(19) United States
(12) Patent Application Publication
(10) Pub. No.: US 2004/0208567 A1
(43) Pub. Date: Oct. 21, 2004

(54) Optical wavelength division multiplexing transmission system

(75) Inventors: Hisanori Okano, Yokohama (JP); Hiroyuki Iwaki, Yokohama (JP); Chikashi Hashimoto, Yokohama (JP); Tatsuhiko Son, Yokohama (JP); Seiji Matsuzaki, Yokohama (JP); Megumi Shibata, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/125,512

(22) Filed: Apr. 19, 2002

(30) Foreign Application Priority Data
Dec. 6, 2001 (JP) 2001-372895

(51) Int. Cl. H04J 14/02

(52) U.S. Cl. 398/79

(57) ABSTRACT

An optical wavelength division multiplexing transmission system is disclosed, in which it is possible to establish a new additional line readily, without affecting lines. The optical wavelength division multiplexing transmission system has a plurality of cascaded transmission devices respectively having optical wavelength division multiplexing functions, and each of the plurality of transmission devices includes a management section for managing used and unused wavelengths, and the respective transmission devices located in a section where a new additional line is to be established allocate an unused wavelength to the new additional line, on the basis of the unused wavelength information held by the management sections, thereby ensuring a route going to the target transmission device.

### BACKGROUND OF THE INVENTION

1. Field of the Invention

The present invention relates to an optical wavelength division multiplexing (WDM) transmission system.

2. Description of the Related Art

FIG. 1 is a diagram showing one compositional example of an optical wavelength division multiplexing transmission system. In FIG. 1, a plurality of transmission devices (NE: Network Equipment) 1-n (in FIG. 1, transmission devices 1-4) are mutually connected by bidirectional lines.

In FIG. 1, the composition in the downstream direction from transmission device 1 to transmission device 4 is the same as the composition in the upstream direction from transmission device 4 to transmission device 1.

Therefore, the composition in the downstream direction from transmission device 1 to transmission device 4 is described here. In FIG. 1, this comprises, on the transmission side of the transmission device 1, a multiplexing section (MUX) 10 which combines a plurality of wavelengths from wavelength λ1-λn, a transmitting amplifier (TA) 11 which optically amplifies the wavelength division multiplexed (WDM) optical signal output by the multiplexing section 10; an optical supervisory channel (OSC optical signal: Optical Supervisory Channel transmission device 1) section 12 for generating and outputting an OSC optical signal for conveying optical signal information, various types of OH (Over Head) information, internal device information, and the like, and a wave coupler 13.

The OSC optical signal from the optical supervisory channel section 12 is combined with the optical output signal from the transmission amplifier 11 by the wave coupler 13, and then output by the transmission device 1.

The intermediate transmission devices 2, 3 have a common composition, wherein the OSC optical signal from the previous transmission device is separated and received by a wave splitter 14. The separated OSC (Optical Supervisory Channel) optical signal is input to an OSC section 15.

On the other hand, the wavelength multiplexed signal from the previous transmission device is optically amplified by a receiving amplifier 16, and is output separately according to each wavelength to paths set by a cross connector device 17, or alternatively, passed on directly without alteration via an output amplifier 18.

Moreover, the optical signal input to the cross connector device 17 and the optical signal passed on from the previous transmission device is optically amplified by a transmitting amplifier 18, and combined with the OSC optical signal generated by the OSC section 19 by the wave coupler 20, whereupon it is sent to the transmission device of the next stage.

In FIG. 1, in the end transmission device 4 also, the OSC optical signal is separated off by the wave splitter 21 and input to the OSC section 22. The optical signal from the preceding transmission device 3 is amplified by a receiving amplifier 23. The optically amplified reception optical signal is separated into optical signals of respective wavelengths from λ1 to λn by a demultiplexing section 24.

In FIG. 1, the aforementioned composition is similar in the direction from the transmission device 4 to the transmission device 1, also.

Here, we shall consider the optical signal input to the cross connector devices 17 in the aforementioned intermediate transmission devices 2, 3.

At present, there is no technique for converting the wavelength of light freely, whilst preserving an optical signal. Therefore, if a new line is added to a route which already employs a large number of wavelengths between transmission devices, then if the wavelength of the added line is being used by a transmission device in the route, this wavelength must be changed to another wavelength. In such cases, the linery is affected during operation.

For example, considering wavelength insertion into the main signal path in FIG. 1 only, if it is supposed that a line of wavelength λ4 in the direction from transmission device 1 to transmission device 4 is added, as shown in FIG. 2, then this wavelength λ4 cannot be used since the wavelength λ4 is already being used in the section from transmission device 3 to transmission device 4.

Consequently, it is necessary to switch from the wavelength λ4 to the unused wavelength λ3 between transmission device 3 and transmission device 4. However, this switching affects the wavelength λ4 line by causing a line disconnection in the section between transmission device 3 and transmission device 4.

### SUMMARY OF THE INVENTION

For this reason, it is an object of the present invention to provide an optical wavelength division multiplexing (WDM) system wherein a new line can be added and unused lines can be activated, without affecting lines that are in use.

In order to achieve the aforementioned object, the first aspect of the present invention is an optical WDM transmission system consisting of: a plurality of cascaded transmission devices respectively having optical WDM functions; wherein the plurality of transmission devices each comprise a management section for managing used and unused wavelengths; and the respective transmission devices located in a section where a new additional line is to be established allocate unused wavelengths to the new additional line, on the basis of the unused wavelength information held by the management sections, thereby ensuring a route going to the target transmission device.

A second aspect of the optical WDM transmission system according to the present invention for resolving the aforementioned object is such that in the first aspect, the respective transmission devices located in the section where the new additional line is to be established preferentially use the same wavelength as the wavelength of the new additional line received from the previous station, when allocating an unused wavelength to the new additional line.

A third aspect of the optical WDM transmission system according to the present invention for resolving the aforementioned object is such that in the second aspect, the respective transmission devices located in the section where the new additional line is to be established preferentially use the same unused wavelength as the wavelength used for the new additional line by the transmission device where the new additional line is added, when allocating an unused wavelength to the new additional line.

A fourth aspect of the optical WDM transmission system according to the present invention for resolving the aforementioned object is such that in the first aspect, the unused wavelength or used wavelength information for all of the respective transmission devices located in the section where the new additional line is to be established is gathered collectively at the transmission device where the new additional line is to be added, and this transmission device where the new additional line is to be added allocates wavelengths, as desired, according to the gathered unused wavelength information.

A fifth aspect of the optical WDM transmission system according to the present invention for resolving the aforementioned object is such that in the first aspect, the unused wavelength or used wavelength information for all of the respective transmission devices located in the section where the new additional line is to be established is gathered collectively at an end transmission device serving as an information gathering station, and the information gathering station allocates wavelengths, as desired, according to the gathered unused wavelength information.

A sixth aspect of the optical WDM transmission system according to the present invention for resolving the aforementioned object is such that in the fifth aspect, the respective transmission devices located in the section where the new additional line is to be established preferentially use the same unused wavelength as the wavelength used for the new additional line by the transmission device where the new additional line is added, when allocating an unused wavelength to the new additional line.

A seventh aspect of the optical WDM transmission system according to the present invention for resolving the aforementioned object is such that in the fifth aspect, the respective transmission devices located in the section where the new additional line is to be established preferentially use the most common unused wavelength in the respective transmission devices, when allocating an unused wavelength to the new additional line.

An eighth aspect of the optical WDM transmission system according to the present invention for resolving the aforementioned object is such that in the fifth aspect, wherein the respective transmission devices located in the section where the new additional line is to be established preferentially use the most common continuous unused wavelength, when allocating an unused wavelength to the new additional line.

A ninth aspect of the optical WDM transmission system according to the present invention for resolving the aforementioned object is such that in the first aspect, the unused wavelength or used wavelength information for all of the respective transmission devices located in a plurality of sections where respective additional lines are to be established is gathered collectively at an end transmission device serving as an information gathering station, and the information gathering station allocates wavelengths, as desired, according to the gathered unused wavelength information.

A tenth aspect of the optical WDM transmission system according to the present invention for resolving the aforementioned object is such that in the ninth aspect, the respective transmission devices located in the sections where the new additional lines are to be established preferentially use the same unused wavelength as the wavelength used for the new additional line by the transmission device where the new additional line is added, when allocating an unused wavelength to the new additional line.

An eleventh aspect of the optical WDM transmission system according to the present invention for resolving the aforementioned object is such that in the first aspect, the respective transmission devices located in the sections where the new additional lines are to be established preferentially use the most common unused wavelength in the respective transmission devices, when allocating an unused wavelength to the new additional line.

A twelfth aspect of the optical WDM transmission system according to the present invention for resolving the aforementioned object is such that in the ninth aspect, the respective transmission devices located in the sections where the new additional lines are to be established preferentially use the most common continuous unused wavelength, when allocating an unused wavelength to the new additional line.

Further characteristic features of the present invention will become apparent from the embodiments described below with reference to the drawings.

### BRIEF DESCRIPTION OF THE DRAWINGS

FIG. 1 is a diagram showing one compositional example of a WDM transmission system;

FIG. 2 is a diagram illustrating the introduction of a new wavelength into the main signal path in FIG. 1;

FIG. 3 is a schematic diagram of the present invention for description in relation to FIG. 2;

FIG. 4 is an application example of a transmission device using the principles of the present invention as described in FIG. 3;

FIG. 5 is a diagram showing a compositional example of a switch (SW) 170 of a cross connector device 17;

FIG. 6 is a diagram illustrating a first embodiment of the present invention;

FIG. 7 is a flowchart of the processing implemented in the respective transmission devices corresponding to the embodiment in FIG. 6;

FIG. 8 is a diagram illustrating a second embodiment of the present invention;

FIG. 9 is a flowchart of the processing implemented in the respective transmission devices corresponding to the embodiment in FIG. 8;

FIG. 10 is a third embodiment of the present invention;

FIG. 11 is a flowchart of the processing implemented in the respective transmission devices of the embodiment in FIG. 10;

FIG. 12 is an example of a system composition for implementing a fourth embodiment of the present invention;

FIG. 13 is a flowchart of the processing implemented by the transmission device where a new line is added in FIG. 12;

FIG. 14 is a flowchart of the processing implemented by transmission devices other than the transmission device where the new line is added in FIG. 12 and the end transmission devices;

FIG. 15 is a diagram of a further embodiment corresponding to the embodiment in FIG. 12;

FIG. 16 is an example of a system composition for implementing a fifth embodiment of the present invention;

FIG. 17 is a flowchart of processing implemented by the information gathering station in FIG. 16;

FIG. 18 is a diagram showing a further embodiment corresponding to the embodiment in FIG. 15;

FIG. 19 is an example of a system composition for implementing a sixth embodiment of the present invention;

FIG. 20 is a diagram showing a flowchart of the processing in a transmission device 1 forming an information gathering station corresponding to FIG. 19, until line establishment;

FIG. 21 is a seventh embodiment of the present invention, wherein a new line is added from transmission device 2 to transmission device 7;

FIG. 22 is a flowchart of processing implemented by transmission device 1 forming an information gathering station corresponding to FIG. 21;

FIG. 23 is an example of a system composition for implementing an eighth embodiment of the present invention;

FIG. 24 is a flowchart of processing implemented by transmission device 1 forming an information gathering station corresponding to FIG. 23;

FIG. 25 is an example of a system composition for implementing a ninth embodiment of the present invention;

FIG. 26 is a flowchart of processing implemented by transmission device 1 forming an information gathering station corresponding to FIG. 25;

FIG. 27 is an example of a system composition for implementing a tenth embodiment of the present invention;

FIG. 28 is a flowchart of processing implemented by an information gathering station corresponding to the embodiment in FIG. 27;

FIG. 29 is an example of a system composition for implementing an eleventh embodiment of the present invention;

FIG. 30 is a flowchart of processing implemented by an information gathering station corresponding to FIG. 29;

FIG. 31 is an example of a system composition for implementing a twelfth embodiment of the present invention; and

FIG. 32 is a flowchart of processing implemented by an information gathering station corresponding to FIG. 31.

### DESCRIPTION OF THE PREFERRED EMBODIMENTS

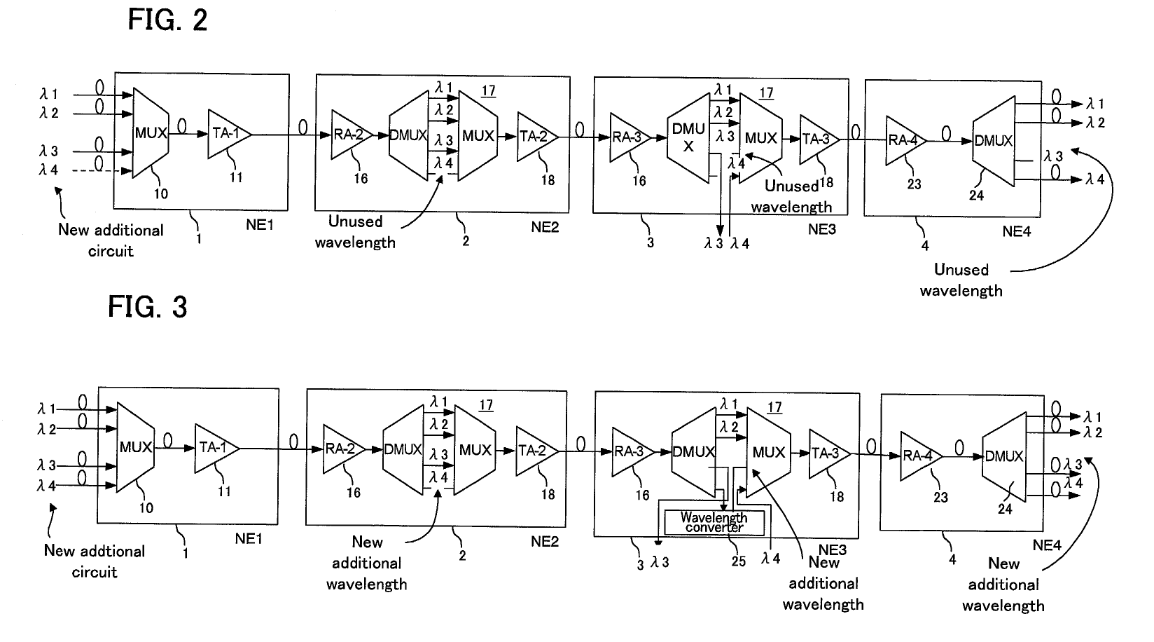

FIG. 3 shows a schematic diagram of the present invention which is described here in comparison to FIG. 2.

The wavelength λ4 that is to be added in the transmission device 1 is already being used for transmission from transmission device 3 to transmission device 4. Therefore, the optical signal of wavelength λ4 cannot be transmitted from transmission device 1 through to transmission device 4. However, wavelength λ3 is used between transmission device 3 and transmission device 4.

Consequently, if it is sought to use wavelength λ4, an optical signal is transmitted at the added wavelength λ4 from transmission device 1 to transmission device 3, and at transmission device 3 the wavelength of the optical signal of wavelength λ4 is converted to λ3 by a wavelength converter 25.

The optical signal converted to wavelength λ3 is introduced at the transmission device 3 and transmitted to transmission device 4. Thereby, the optical signal of wavelength λ4 introduced at the transmission device 1 can be sent through to transmission device 4.

At the present time, technology does not exist for converting the wavelength of an optical signal directly, as described above.

Therefore, the wavelength converter 25 first converts the optical signal to an electrical signal, and then converts the electrical signal back to an optical signal. Thereby, it is possible to convert an optical signal of λ4 to an optical signal of λ3. Naturally, if it were possible to achieve a technique for converting the wavelength of the optical signal directly, then this would be applied desirably in the present invention.

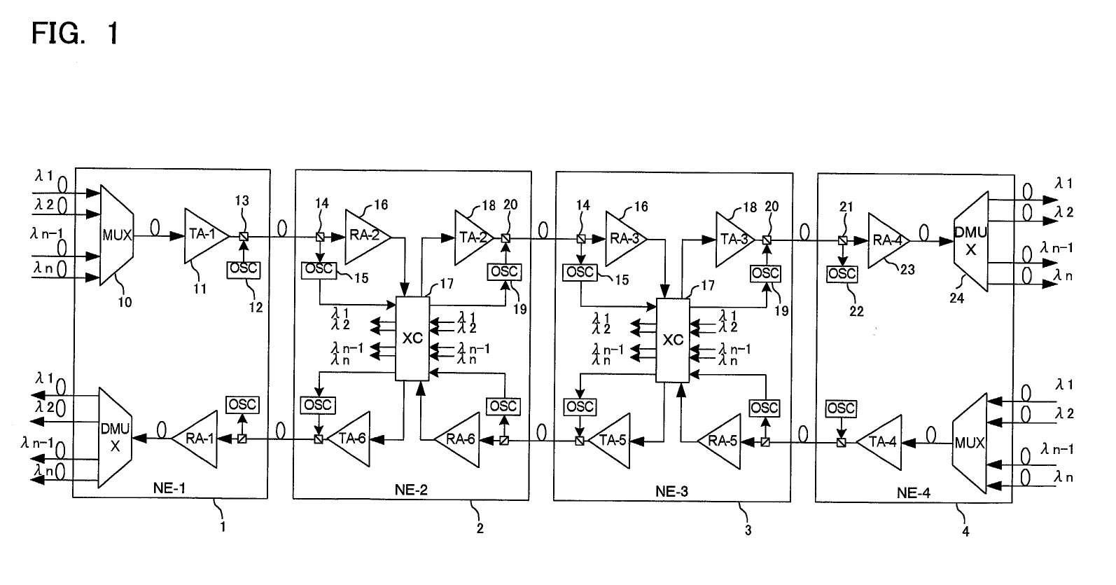

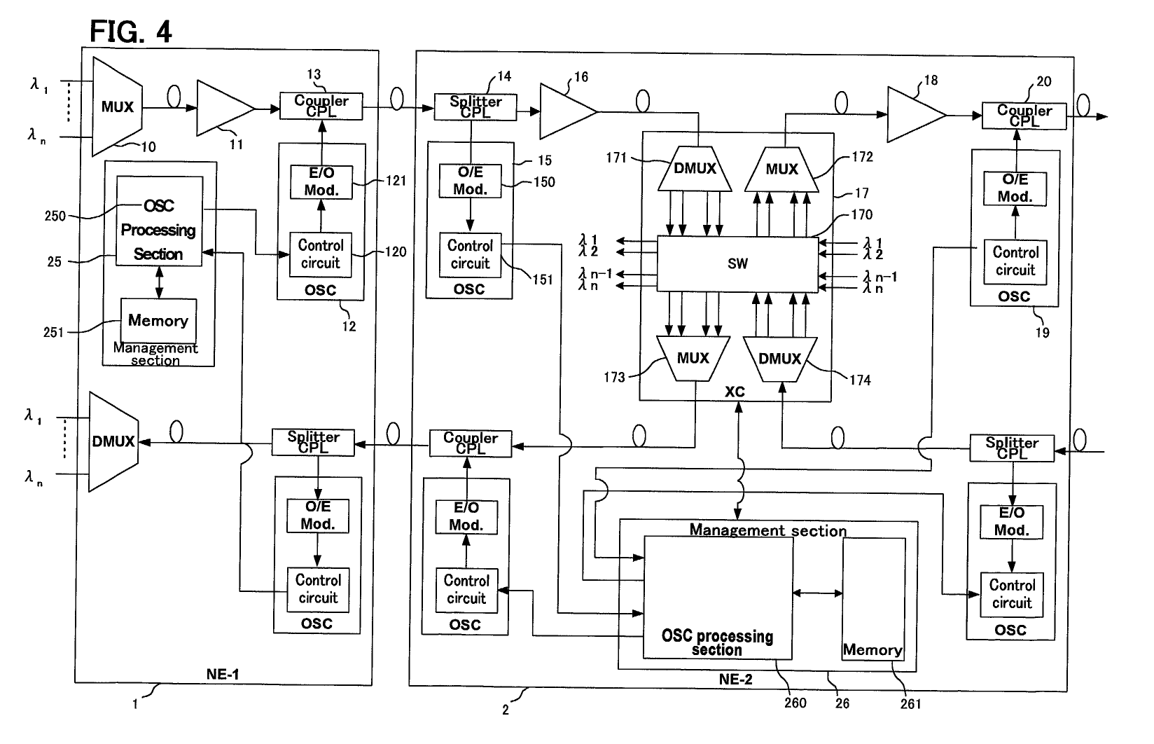

FIG. 4 shows an application example of a transmission device using the principles of the present invention as described in FIG. 3. This diagram shows the composition of the end transmission device 1 and the intermediate transmission device 2 corresponding to FIG. 1, but the intermediate transmission device 3 and the end transmission device 4 are of a similar composition.

In FIG. 4, the characteristic feature of the transmission devices 1, 2 is that they respectively comprise management sections 25, 26. The management sections 25, 26 respectively comprise an OSC optical signal processing sections 250, 260 and a memory 251, 261.

The unused wavelength and used wavelength information for the corresponding transmission devices is registered in the memories 251, 261. When a newly added line is to be established in the end transmission device 1, the unused wavelength and used wavelength information is referenced in the memory 251 of the management section 25, under the control of the OSC optical signal processing section 250. Thereupon, an unused wavelength is selected on the basis of the referenced information.

The wavelength information thus selected is reported to the OSC section 12 by the OSC optical signal processing section 250. In the OSC section 12, a selected wavelength information signal is generated by the control line 120, the generated signal is converted to an OSC optical signal by electrical/optical converter 121, this signal is combined with the main WDM optical signal from the multiplexing section 10 by the multiplexer 13, and sent to the intermediate transmission device 2.

In the intermediate transmission device 2, the OSC optical signal containing selected wavelength information is split by the wave splitter 14, and converted to an electrical signal in the OSC section 15. The selected wavelength information converted to an electrical signal is input by the control line 151 to the OSC optical signal processing section 260 of the management section 26.

The OSC optical signal processing section 260 searches the memory 261 on the basis of the selected wavelength information and detects an unused wavelength which can be newly introduced into the transmission device 2.

Consequently, the cross connector device 17 is controlled by the management section 26 and the wavelength is established, in such a manner that an optical signal of the unused wavelength thus found can be transmitted. Thereby, the route up to the target station is ensured, without using a wavelength that is already in use.

The switch (SW) 170 of the cross connector device 17 performs the operations of introducing (ADD), splitting (DROP) and passing (THROUGH) with respect to the optical signals which are split into separate wavelengths by the demultiplexing sections 171, 174, according to information from the OSC optical signal processing section 260 of the management section 26.

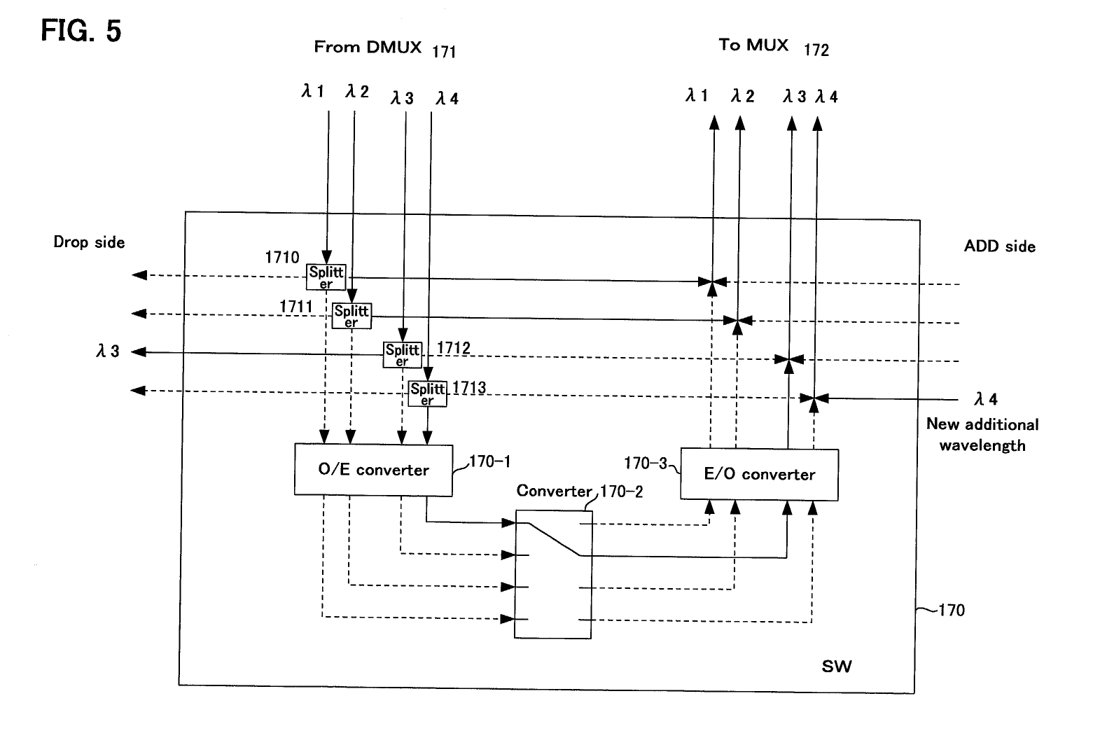

FIG. 5 shows a compositional example of the switch (SW) 170 of the cross connector device 17. The example in FIG. 5 relates to the transmission device 3 shown in FIG. 3, in a case where the wavelength is converted in the line running from transmission device 1 to transmission device 4. The switch (SW) 170 has a similar composition when converting the wavelength of the line running from transmission device 4 to transmission device 1.

In FIG. 5, splitter lines 1710-1713 are previously set in such a manner that the wavelengths separated by the wavelength demultiplexing section 171 are directed to either the DROP side, to the multiplexing section 172, or to an optical-electrical converter 170-1. Moreover, the converter 170-2 is set such that is inputs the electrically converted signal from the optical-electrical converter 170-1 and changes the output position thereof from the converter 170-2.

The output from the converter 170-2 is converted to light of a prescribed wavelength by an electrical-optical converter 170-3, and then output to the multiplexing section 172. In the example in FIG. 5, the optical signal of wavelength λ3 sent by the transmission device 2 is dropped by the switch (SW) 170 and the optical signal of wavelength λ4 sent by the transmission device 2 is converted to an optical signal of λ3 by the electrical-optical converter 170-3 and input to the multiplexing section 172.

Thereby, if it is sought to add wavelength λ4 from transmission device 1 to transmission device 4, as shown in the schematic diagram in FIG. 3, then if λ4 is already being used from transmission device 3 to transmission device 4, whilst λ3 is not being used there, then λ3 is used as a wavelength between transmission device 3 and transmission device 4.

In other words, it is possible to add a new line from transmission device 1 to transmission device 4, without switching from the wavelength λ4 between transmission device 3 and transmission device 4 which is already in use.

As described above, the application of the present invention is not limited in essence to wavelength converting technology, but rather lies in a line setting method for activating unused lines. Therefore, desirably, the wavelength conversion (for example, conversion from wavelength λ4 to λ3) involves conversion from optical signal to electrical signal and conversion from electrical signal to optical signal, or alternatively, if it is technically possible, wavelength conversion of the optical signal directly, without passing through electrical/optical conversion.

Below, a concrete example of the application of the present invention is described.

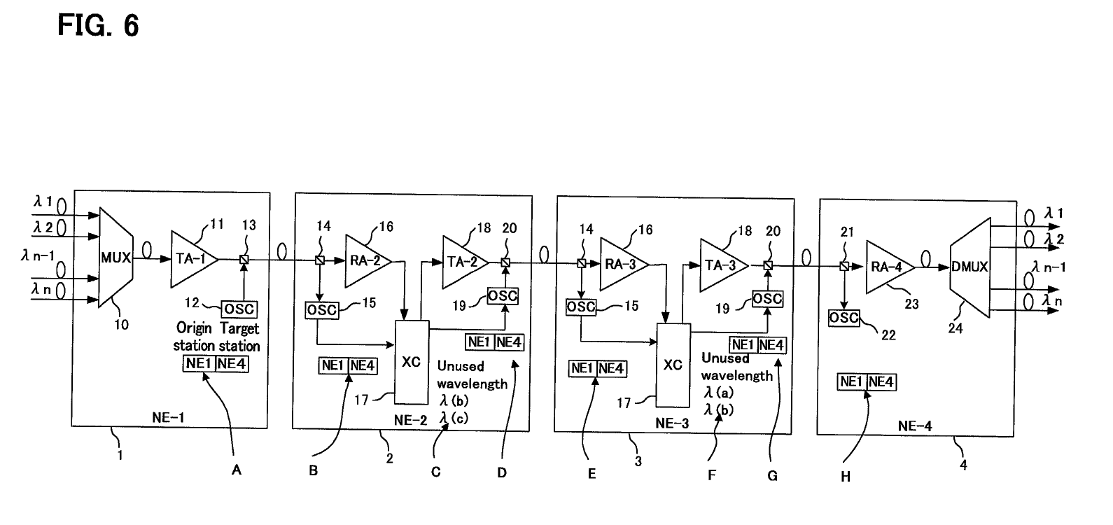

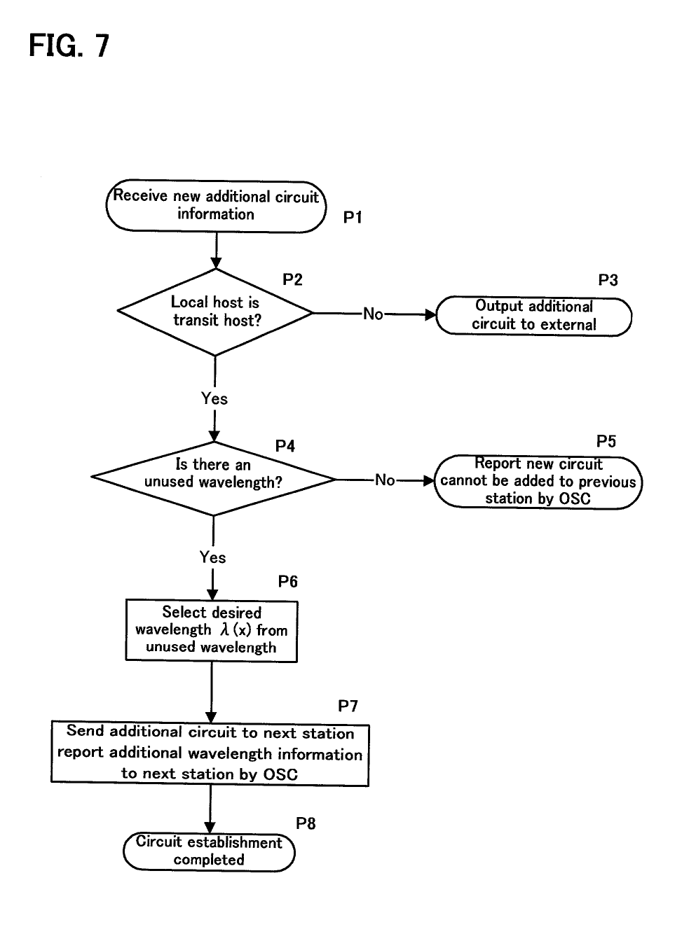

FIG. 6 is a diagram illustrating a first embodiment of the present invention, and similarly to FIG. 3, the composition of the respective transmission devices is depicted in simplified form, in order to facilitate understanding. The same applies to the other embodiments described hereinafter. FIG. 7 is a flowchart of processing in the respective transmission devices corresponding to the embodiment illustrated in FIG. 6. The operation of the embodiment in FIG. 6 is now described with reference to FIG. 7.

If a new line is to be added from the end transmission device 1 to the end transmission device 4, when new additional line information is received from the operator by the transmission device 1, a line of wavelength λ(a) is established taking transmission device 1 as the origin station where the line is added and transmission device 4 as the target station, and a main signal of wavelength λ(a) is transmitted to transmission device 2.

Moreover, the OSC section 12 introduces information relating to the origin station (transmission device 1) and destination information relating to the target station (transmission device 4) (in FIG. 6 this information is indicated by reference symbol A), into the OSC optical signal, which is combined with the aforementioned main signal by the wave coupler 13 and sent to transmission device 2.

Transmission device 2 receives the information (B in FIG. 6) sent by the transmission device 1 in the OSC section 15 (processing step P1). From the target station information thus received, it determines whether or not the local station is a transit station (processing step P2).

If the local station is not a transit station, in other words, if it is the target station (transmission device 4 in the example shown in FIG. 6), then the added line is output externally (processing step P3). If, on the other hand, the local station is a transit station (Yes at processing step P2), then in order to transmit the added line, the memory 261 (see FIG. 4) is searched to see if there is an unused wavelength in that transmission device (processing step P4).

If there is an unused wavelength (in transmission device 2, the unused wavelengths are λ(b) and λ(c): FIG. 6, C), then the transmission device 2 selects a desired wavelength λ(b) of the unused wavelengths (processing step P6). The main signal is then sent via the transmitter amplifier 18 and wave coupler 20 to transmission device 3, using the added line having a selected wavelength of λ(b).

At the same time, the OSC section 19 of the transmission device 2 adds information for the origin station (transmission device 1) and destination information (FIG. 6, D) relating to the target station (transmission device 4) to the OSC optical signal by means of the OSC section 19 and sends sane to the transmission device 3 (processing step P7).

Simultaneously with the processing in the transmission device 2, the OSC section 15 of the transmission device 3 determines that the local station is not the target station, on the basis of the information (FIG. 6, E) sent by transmission device 2, and hence it searches the memory 261 to see whether or not there is an unused wavelength in order to send the added line on to the next station.

If only wavelengths λ(b) and λ(c) are unused in the transmission device 3 (FIG. 6, F), then the transmission device 3 sends the added main signal to transmission device 4 using the desired wavelength λ(b) selected from the unused wavelengths.

At the same time, information for the origin station (transmission device 1) and destination information (FIG. 6, G) relating to the target station (transmission device 4) is introduced to the OSC section 19 and sent to the transmission device 4. The OSC section 15 of transmission device 4 recognizes from the information (FIG. 6, H) sent by transmission device 3 that the local station is the target station, and it outputs the wavelength externally. In this way, the establishment of the added line in the respective transmission devices is completed (processing step P8).

If, at processing step P4 above, it is determined as a result of the searching of the respective transmission devices that there is no unused line, then an alarm indicating that addition of a new line is impossible is issued, and reported to the origin station (transmission device 1) by means of the OSC optical signal (processing step P5).

Here, the processing from transmission device 4 to transmission device 1 is the same as that described above, and it is possible to send information to the transmission devices from transmission device 4 by means of the OSC optical signal.

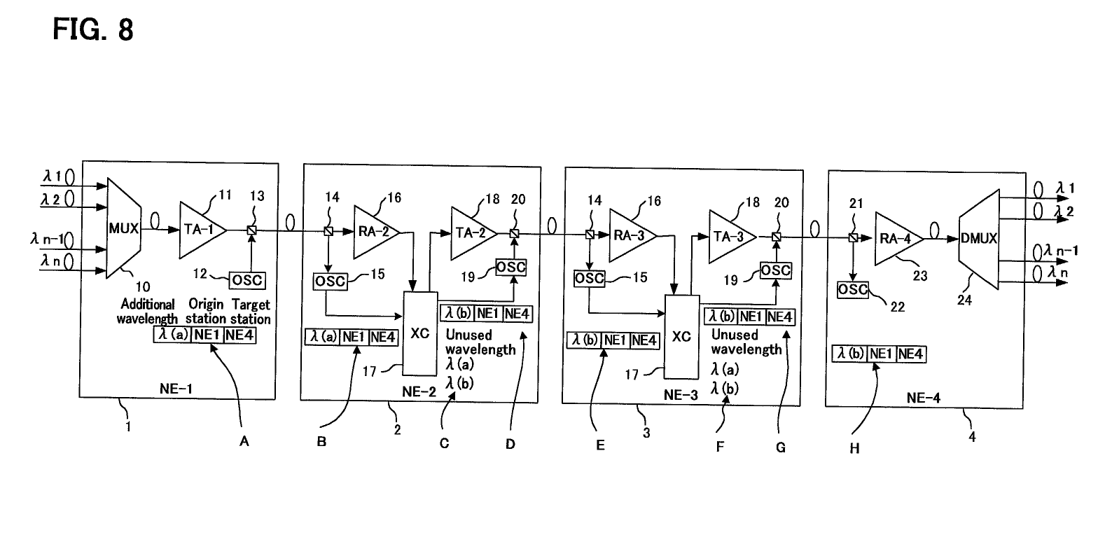

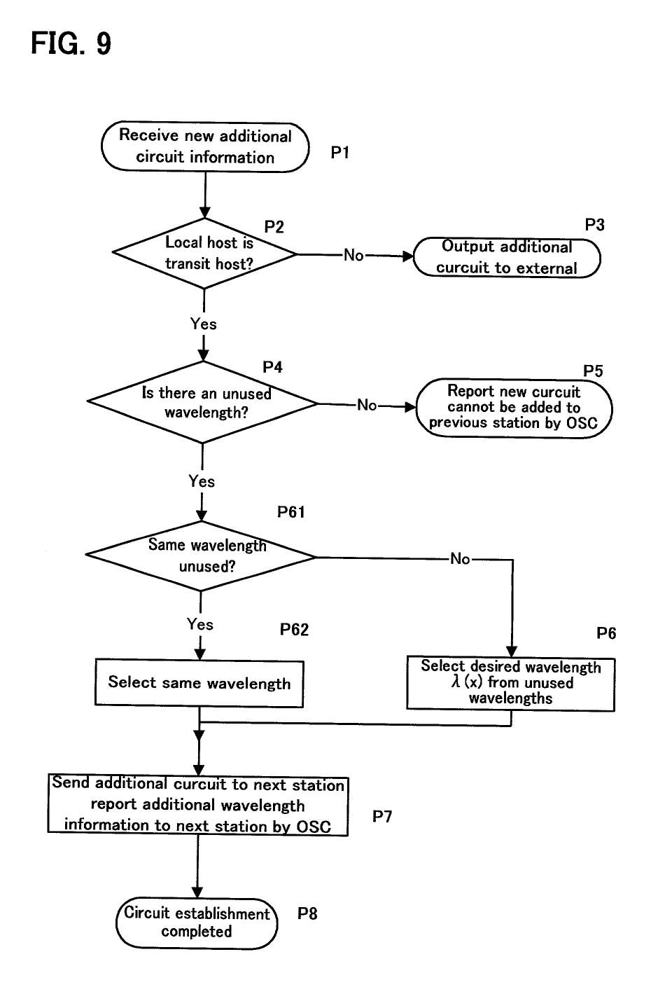

FIG. 8 shows an example of a system composition for describing a second embodiment of the present invention. Similarly to the example in FIG. 6, the composition of the respective transmission devices has been omitted from the illustration. FIG. 9 is a processing flow diagram of the respective transmission devices corresponding to the embodiment in FIG. 8. The operation of FIG. 8 is now described with reference to FIG. 9.

If adding a new line between transmission device 1 and transmission device 4, when new additional line is received from the operator, an additional line having wavelength λ(a) is established, and a main signal is sent to transmission device 2 at wavelength λ(a). Moreover, information relating to the additional wavelength λ(a) set by transmission device 1, information relating to the origin station (transmission device 1), and destination information (FIG. 8, A) relating to the target station (transmission device 4) is added to the OSC optical signal by the OSC section 12 and sent to the transmission device 2.

The OSC section 15 of transmission device 2 receives the information (FIG. 8, B) sent by transmission device 1 (processing step P1) and determines whether or not the local station is a transit station on the basis of this information (processing step P2).

If it is judged that the local station is not a transit station (and therefore, is the target station) (No at processing step P2), then the additional line is output externally (processing step P3).

If it is judged that the local station is a transit station (and therefore, is not the target station) (Yes at processing step P2), then the memory 261 is searched to see whether or not there is an unused wavelength in order to send the added line to the next station (processing step P4).

If there is no unused wavelength, then a report is issued by the OSC optical signal to the next station to indicate that addition of the new line is not possible (processing step P5).

If, on the other hand, only wavelength λ(b) and λ(c) are unused in transmission device 2 (FIG. 8, C), then since the transmission device 2 is using wavelength λ(a), wavelength λ(b) is selected preferentially as the added wavelength (processing step P6). A main signal is transmitted to transmission device 3 using the added line of the selected wavelength λ(b).

At the same time, the OSC section 19 of the transmission device 2 adds information relating to the added wavelength λ(b) established at transmission device 2, information for the origin station (transmission device 1) and destination information relating to the target station (transmission device 4) (FIG. 8, D), to the OSC optical signal, and sends it to the transmission device 3.

The OSC section 15 of transmission device 3 determines that the local station is not the target station from the information (FIG. 8, E) sent by the transmission device 2, and it searches the memory 261 to see whether or not there is an unused wavelength in order to send the added line to the next station.

If the wavelengths λ(a) and λ(b) only are unused in transmission device 3 (FIG. 8, F), then the OSC section 19 of the transmission device 3 identifies that the added wavelength from the transmission device 2 has a wavelength of λ(b) (Yes at processing step P61), and it selects the same wavelength λ(b) from the unused lines (processing step P62), whereas if the same wavelength λ(b) cannot be used, then it will select one of the unused wavelengths λ(x) as desired (processing step P6), and use this to send the added main signal to transmission device 4.

At the same time, OSC section 19 adds information relating to the added wavelength λ(b), information relating to the origin station (transmission device 1) and destination information (FIG. 8, G) for the target station (transmission device 4), to the OSC optical signal, and sends it to transmission device 4 (processing step P7).

The OSC section 22 of transmission device 4 recognizes from the information (FIG. 8, H) sent by transmission device 3 that the local station is the target station, and output this wavelength externally (processing step P3).

However, if it is determined as a result of the searching the memory 261 of the respective transmission devices that there is no unused line, then an alarm indicating that addition of a new line is impossible is issued, and reported to the preceding station (processing step P5).

The transmission of information from transmission device 4 to transmission device 1 is the same as that described above.

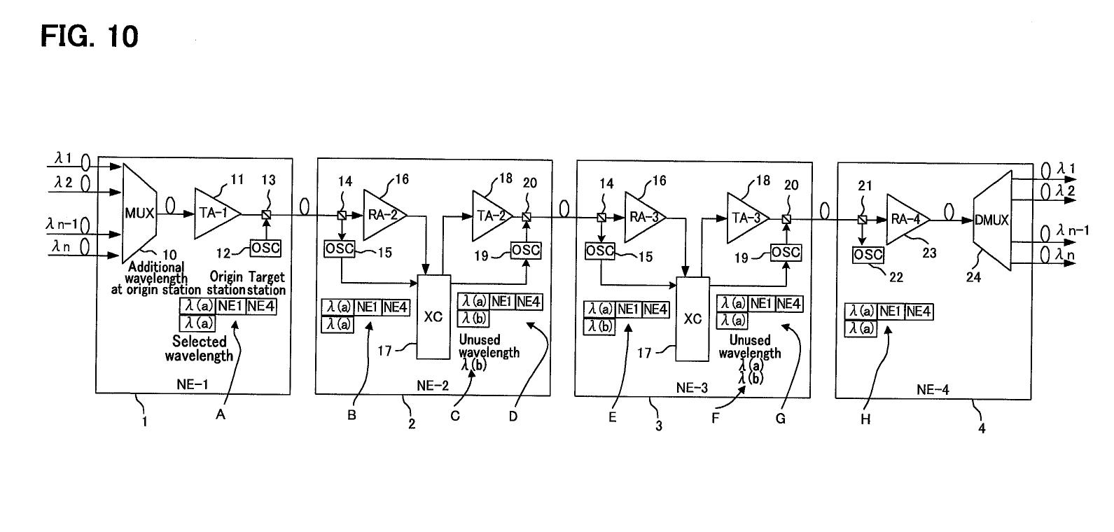

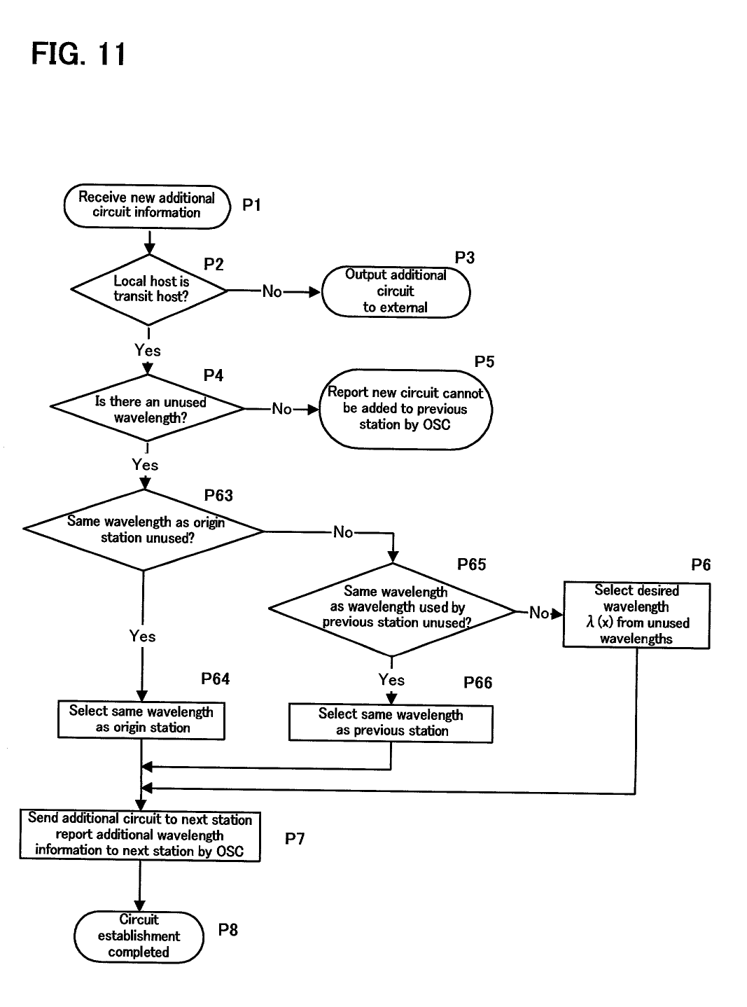

FIG. 10 shows a third embodiment of the present invention. FIG. 11 is a flowchart of the processing in the respective transmission devices in the embodiment illustrated in FIG. 10. The operation of FIG. 10 is now described with reference to FIG. 11.

In FIG. 10, if a new line is to be added between transmission device 1 and transmission device 4, the OSC section 12 of transmission device 1 establishes an additional line of wavelength λ(a), and sends a main signal of wavelength λ(a) to transmission device 2.

The OSC section 12 also adds information relating to the added wavelength λ(a) established by transmission device 1, the origin station (transmission device 1), and destination information (FIG. 10, A) for the target station (transmission device 4), to the OSC optical signal, and sends it to transmission device 2.

The OSC section 15 of transmission device 2 receives the information (FIG. 10, B) sent by transmission device 1 (processing step P1). On the basis of this information, it judges that the local station is not the target station (Yes at processing step P2), and searches the memory 261 to see whether or not there is an unused wavelength in order to send the added line to the next station (processing step P4).

If the same wavelength as the origin station (the preceding station in the case of transmission device 2) is not unused (No at P63, P65), and only λ(b) is unused in transmission device 2 (FIG. 10, C), then the OSC section 19 will add information relating to the added wavelength λ(a) established by transmission device 1, information relating to the wavelength λ(b) to be used by transmission device 2, and information for the origin station (transmission device 1) and target station (transmission device 4) (FIG. 10, D), to the OSC optical signal and then send this to the transmission device 3 (processing steps P6, P7).

Transmission device 3 judges from the information (FIG. 10, E) sent by the transmission device 2 that the local station is not the target station (Yes at processing step P2), and it searches the memory 261 for an unused wavelength in order to send the added line to the next station (processing step P4).

If both wavelengths λ(a) and λ(b) are unused at transmission device 3 (FIG. 10, F), then the OSC section 19 selects the wavelength λ(a) which corresponding to the additional wavelength information established by the origin transmission device 1 (processing steps P63, P64).

The OSC section 19 then adds the information relating to the λ(a) to be added and the origin station (transmission device 1), as well as destination information relating to the target station (transmission device 4) (FIG. 8, G), to the OSC optical signal, and sends this to transmission device 4 (processing step P7).

The OSC section 22 of transmission device 4 recognizes from the information (FIG. 10, H) sent by transmission device 3 that the local station is the target station, and it outputs the wavelength externally (processing step P3).

However, if it is determined as a result of the searching of the respective transmission devices that there is no unused line, then an alarm indicating that addition of a new line is impossible is issued, and reported to the origin station (transmission device 1) (processing step P5). In this way, line setting is completed (processing step P8).

The information sent from transmission device 4 to transmission device 1 is similar to the foregoing.

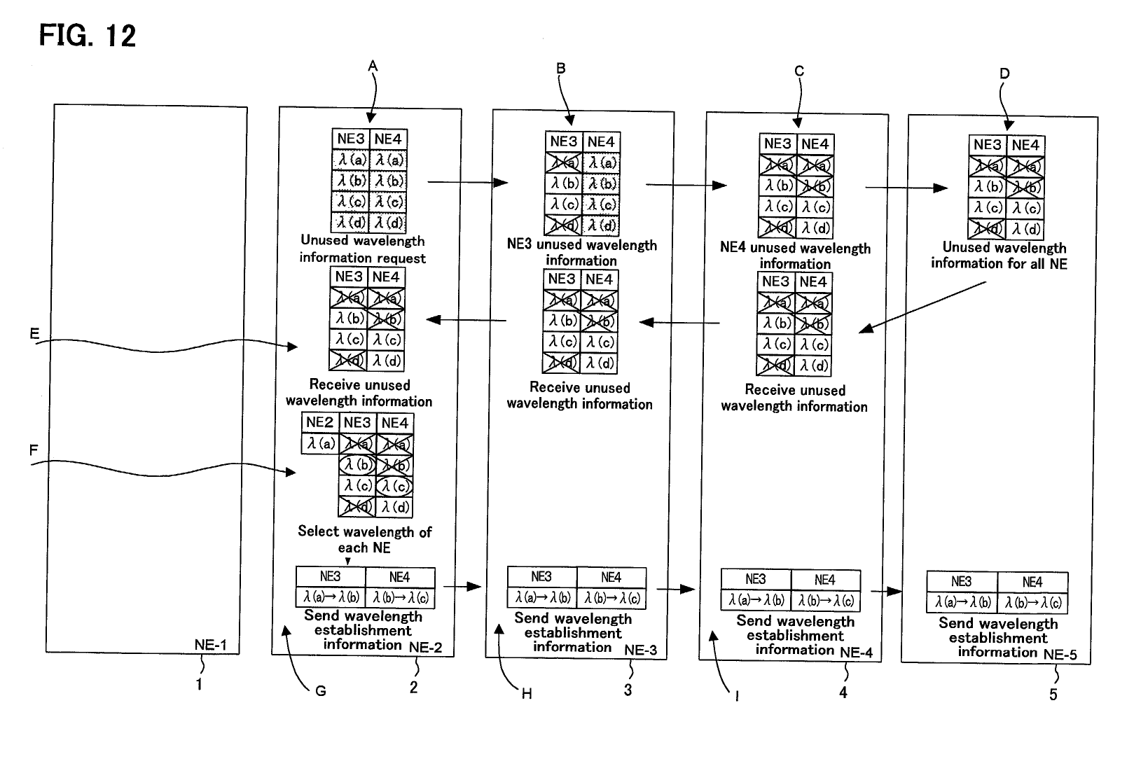

FIG. 12 is an example of a system composition for implementing a fourth embodiment of the present invention. Since the composition of the transmission devices is the same as that in the first to third embodiments described above, in order to facilitate understanding, only the information exchanged between the respective transmission devices and the status of wavelength selected will be explained in the description of this and subsequent embodiments.

In FIG. 12, there are five connected transmission devices. Moreover, whereas in the first to third embodiments, unused wavelengths are selected individually by each transmission device, a characteristic feature of this and subsequent embodiments is that the origin transmission device, or an information gathering station, gathers information relating to all of the transmission devices covering the section where a new additional line is to be established, by means of the OSC optical signal.

Thereby, the origin transmission device is able to select wavelengths for the respective transmission devices, unilaterally.

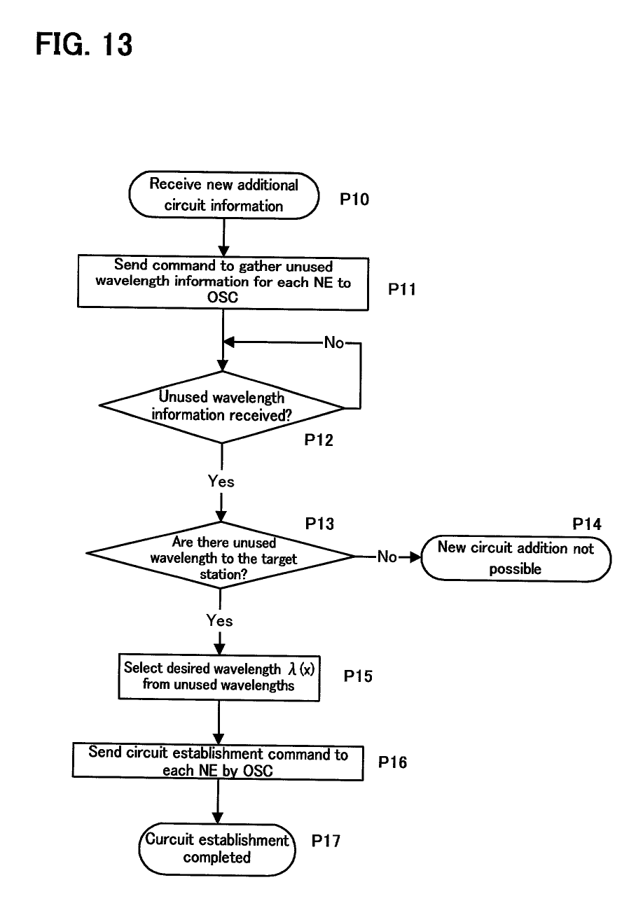

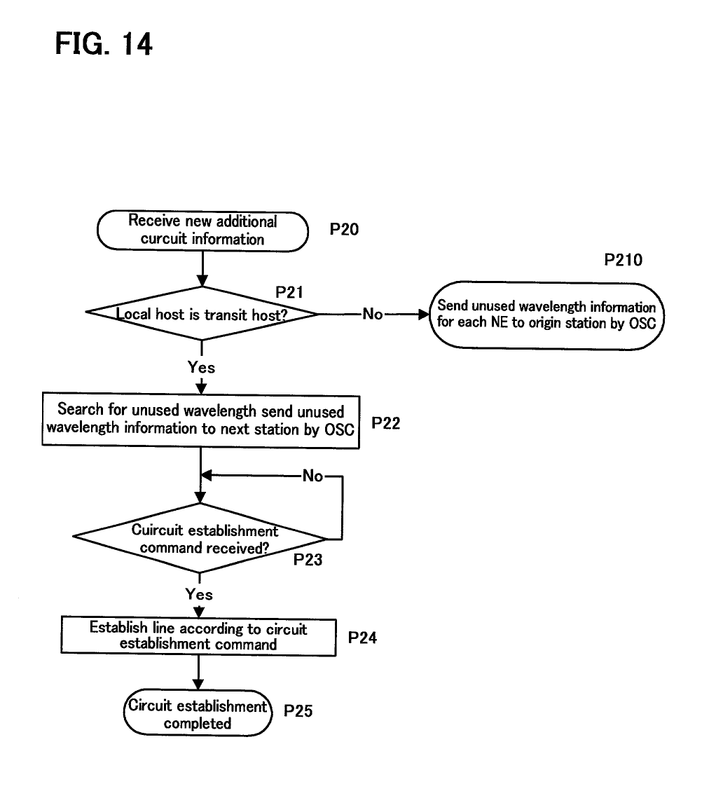

FIG. 13 is a flowchart of the processing in the transmission device which adds the new line in FIG. 12 (transmission device 2 in the example shown in FIG. 12). Moreover, FIG. 14 is a flowchart of the processing in the transmission devices other than the transmission device where the new line is added and the end transmission devices. The operation of the embodiment in FIG. 12 is now described with reference to FIG. 13 and FIG. 14.

In FIG. 12, when the transmission device 2, which is the transmission device where the new line is to be added, receives new additional line information from the operator (not illustrated) (processing step P10), the OSC section of the transmission device 2 sends a command (FIG. 12, A) for gathering unused wavelength information for transmission device 3 and transmission device 4, by means of the OSC optical signal (processing step P11).

In other words, if the wavelength of the additional line to be introduced at transmission device 2 is λ(a), then the OSC section of transmission device 2 sends an unused wavelength information gathering request (FIG. 12, A) to transmission device 3, by means of the OSC optical signal (processing step P11).

Upon receiving this unused wavelength information gathering request (processing step P20), the transmission device 3 determines whether the local station is a transit station (processing step P21), and if the local station is a transit station (Yes at processing step P21), then it searches the memory 261 for unused wavelengths, and sends the unused wavelengths for transmission device 3 thus obtained (FIG. 12, B) to the next station, in other words, to transmission device 4, via the OSC optical signal (processing step P22).

In a similar manner, the transmission device 4 adds unused wavelength information for transmission device 4 (FIG. 12, C), and sends it to the next station, in other words, transmission device 5 (processing step P210).

If the local station is not a transit station (No at processing step P21), in other words, at transmission device 5 which is the target station, the unused wavelength information (FIG. 12, D) received from the respective transmission devices is assembled and sent back to transmission device 2, which is the origin station, successively, via the preceding stations, by means of the OSC optical signal (processing step P21).

The OSC section of transmission device 2 receives this unused wavelength information (FIG. 12, E) for the respective transmission devices as sent by transmission device 5 (Yes at processing step P12). On the basis of the unused wavelength information (FIG. 12, E) for the respective transmission devices thus received, it then determines if there exist unused wavelengths through to the target station (processing step P13). If there are no unused wavelengths through to the target station, then it is considered that addition of the new line is not possible (processing step P14).

If this is not the case, then wavelengths λ(x) are selected as desired from the unused wavelengths of the respective transmission devices (FIG. 12, F: processing step P15). Information for these wavelengths is then sent to the OSC sections of the respective transmission devices, by means of the OSC optical signal, and the wavelengths are established (FIG. 12, G, H, I: processing steps P16, P17).

In this example, transmission device 3 sets λ(b) (FIG. 12, H), and transmission device 4 sets λ(c) (FIG. 12, I).

The information sent from transmission device 5 to transmission device 2 is similar to the foregoing. However, if the line information for transmission device 5 is not required, as in this example, then the information sent to transmission device 5 (FIG. 12, D) can be omitted, and the information can be returned from transmission device 4 to transmission device 2 (FIG. 12, E).

In the example in FIG. 12, a line is established wherein λ(a) is used in transmission device 2, λ(b) is used in transmission device 3 and λ(c) is used in transmission device 4. Here, it is possible to use a different composition to the method of the embodiment shown in FIG. 12, wherein the unused wavelength information for the respective transmission devices is gathered collectively and then sent back to the origin station (in this case, transmission device 2).

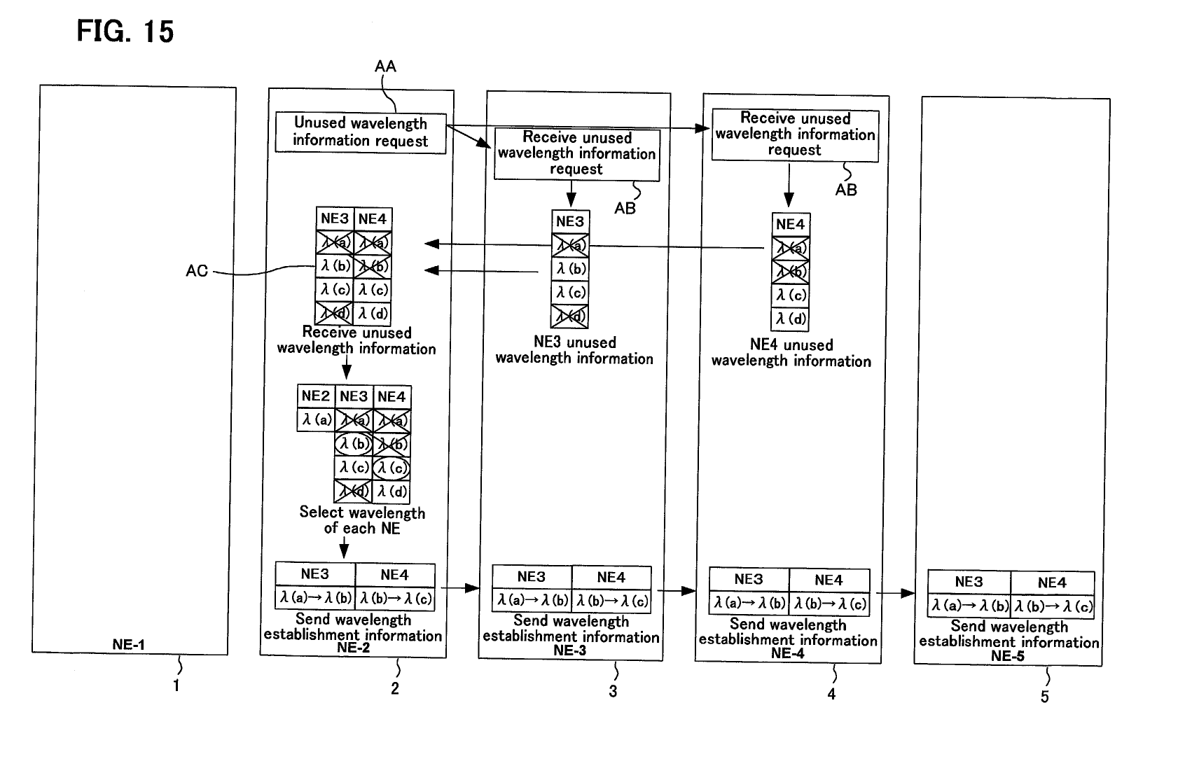

In other words, as in the further embodiment illustrated in FIG. 15, it is also possible for the transmission device 2 which is the origin station to issue an unused wavelength information request (FIG. 15, AA), which is received by the respective transmission devices (FIG. 15, AB), the unused line information being gathered individually by the receiving transmission devices 3, 4 and being assembled by the origin station (transmission device 2) (FIG. 15, AC).

In the embodiments in FIG. 12 and FIG. 15, the origin transmission device 2 knows the set wavelengths of all the transmission devices in advance. Thereby, it is able to reset the wavelength selected by the operator via OSC section to any other wavelength.

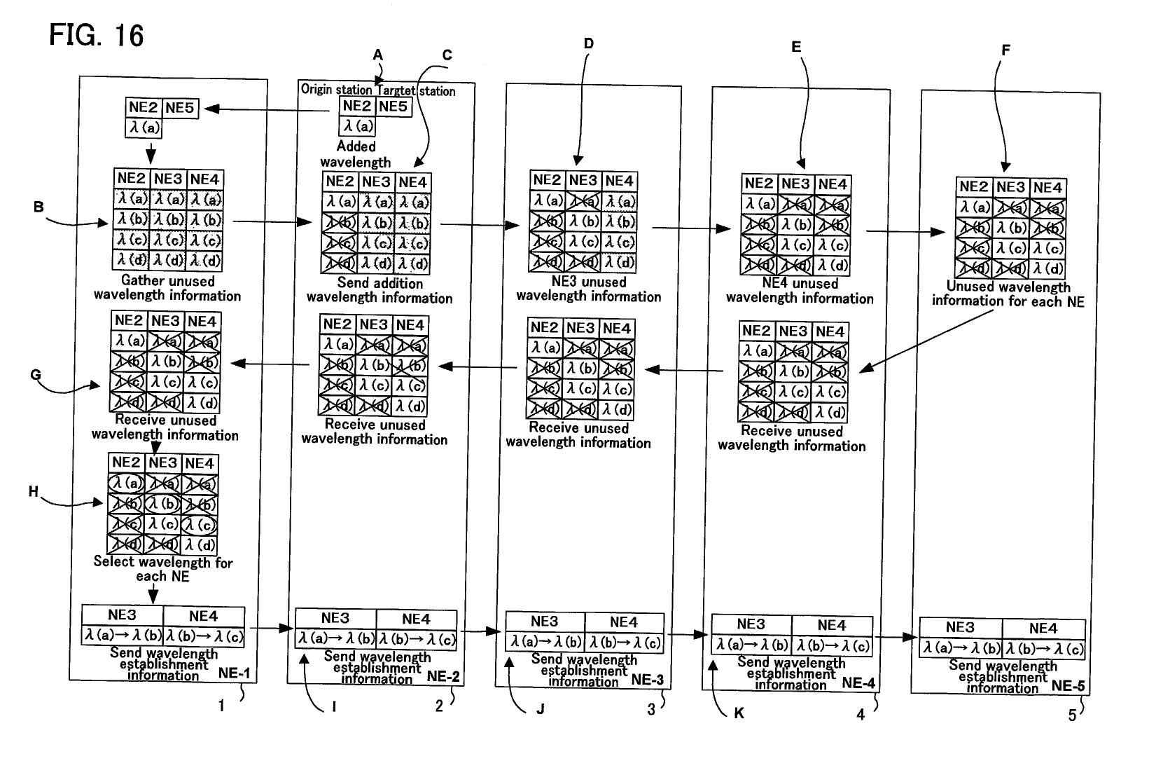

FIG. 16 shows an example of the system composition for implementing a fifth embodiment of the present invention. This embodiment differs from the fourth embodiment above in that the origin transmission device does not gather information for all of the transmission devices in the section where the new additional line is to be established, by means of the OSC optical signal. A composition is adopted wherein one of the transmission devices is set as an information gathering station, and this transmission device gathers the information relating to all the transmission devices in the section where the new additional line is to be established, by means of the OSC optical signal. Thereby, the information gathering station is able to select the wavelengths of the respective transmission devices, unilaterally.

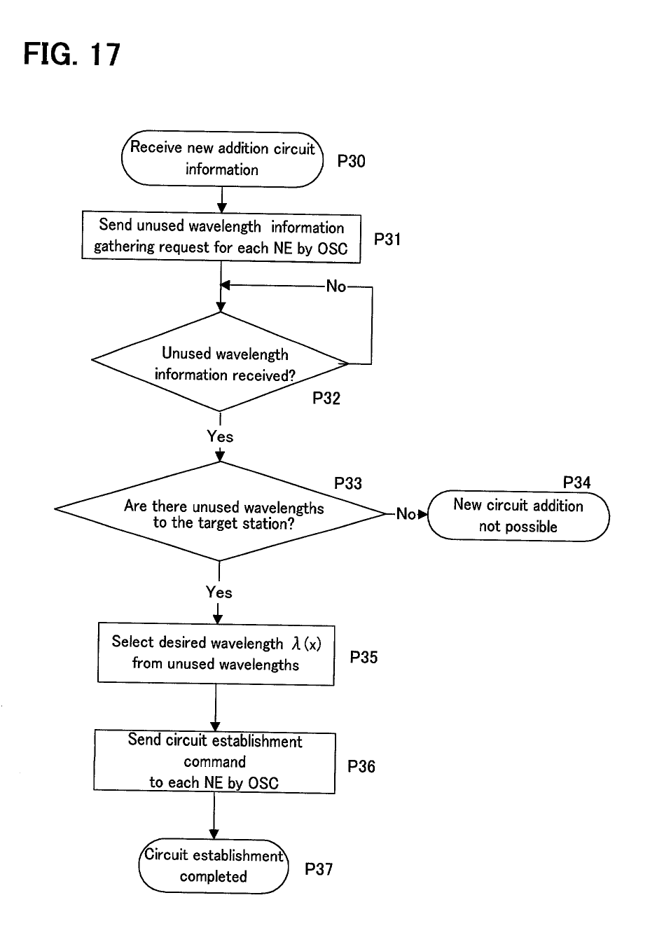

FIG. 17 is a flowchart of processing in an information gathering station set up in this manner. The processing of the respective transmission devices is the same as the processing flowchart shown in FIG. 14, and hence description thereof is omitted here. The operation of the embodiment in FIG. 16 is described below with reference to FIG. 17.

In FIG. 16, it is supposed that transmission device 1 is set as the information gathering station, and that a new line is to be added between transmission device 2 and transmission device 5. Firstly, the transmission device 1 forming the information gathering station receives origin station information (transmission device 2), target station information (transmission device 5), and additional wavelength information (λ(a)) from transmission device 2 by means of the OSC section, (FIG. 16, A: processing step P30).

Thereupon, in order to gather the unused wavelength information from transmission device 2 to transmission device 5, transmission device 1 sends an unused wavelength information gathering command to the respective transmission devices by means of the OSC optical signal (FIG. 16, B: processing step P31).

If the new additional wavelength is λ(a) in transmission device 2, then information for λ(a) (FIG. 16, C) is sent to transmission device 3 using the OSC optical signal. At transmission device 3, the OSC section sends information for the unused wavelengths λ(b) and λ(c), plus the information for the new additional wavelength λ(a) from transmission device 2 (FIG. 16, D), to transmission device 4, by means of the OSC optical signal.

Similarly, at transmission device 4, the OSC section sends information for the unused wavelengths λ(c) and λ(d), plus the information for the unused wavelengths λ(b) and λ(c) from transmission device 3, plus the information for the new additional wavelength λ(a) from transmission device 2 (FIG. 16, E), to transmission device 5, by means of the OSC optical signal.

The information gathered at transmission device 5 (FIG. 16, F) is then sent in the reverse direction back to transmission device 1, by means of the OSC optical signal. The OSC section of transmission device 1 verifies the received information (FIG. 16, G), (processing step P32).

From the received information, it then judges whether or not there exist wavelengths capable of reaching the target station, amongst the unused wavelengths of the respective transmission devices (processing step P33), and if there are no unused wavelength which can reach the target station, then addition of the new line is taken to be impossible (processing step P34).

If there are unused wavelengths which reach the target station, then the wavelengths λ(x) are selected as desired (FIG. 16, H: processing step P35). This wavelength selection information is sent to the OSC sections of the respective transmission devices, via the OSC optical signal (processing step P36), and hence the wavelengths are established (FIG. 16, I, J, K: processing step P37).

In this case, the transmission device 3 sets λ(b) (FIG. 16, J) and the transmission device 4 sets λ(c) (FIG. 16, K).

The information sent from transmission device 5 to transmission device 2 is similar to the foregoing. However, if the line information for transmission device 5 is not required, as in this example, then the information sent to transmission device 5 (FIG. 125, F) can be omitted, and the information can be returned from transmission device 4 to transmission device 1 (FIG. 16, G).

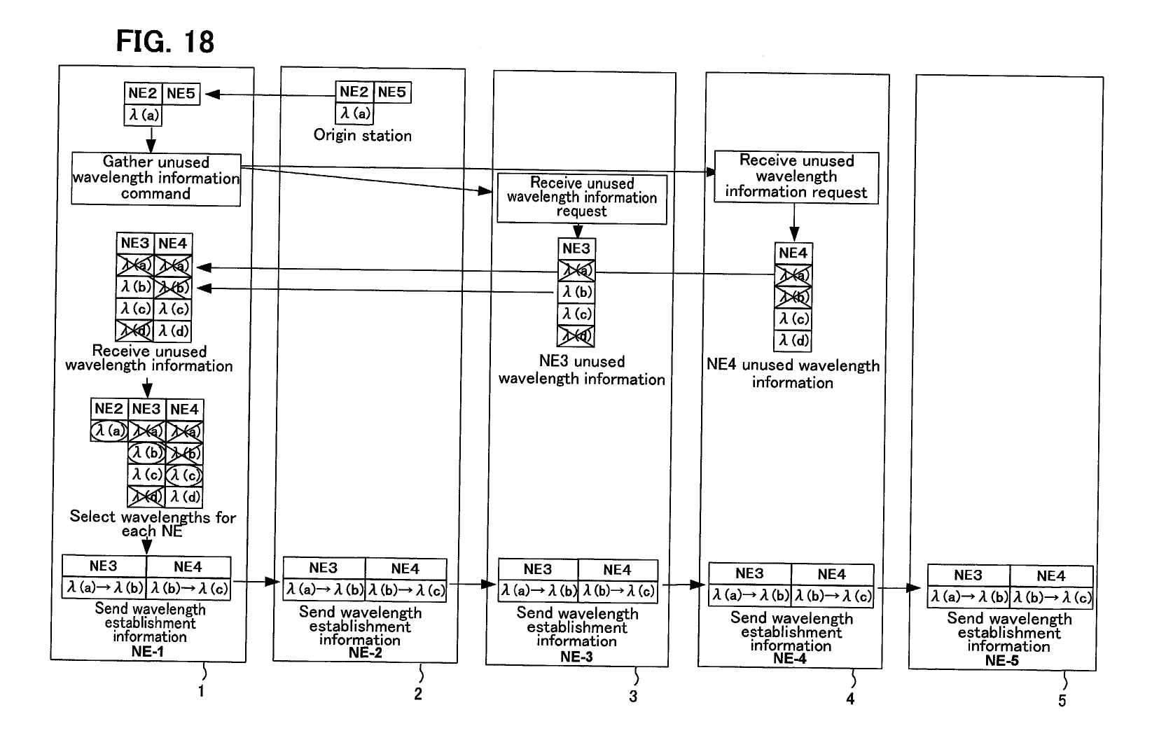

Moreover, rather than gathering the unused wavelength information for the respective transmission devices at the end transmission device and then sending it back to the information gathering station, as in the foregoing example, it is also possible to apply the method of this embodiment by means of the information gathering station (in this case, transmission device 1) sending an unused wavelength information request to each of the respective transmission devices, which then send unused wavelength information back individually, this information being assembled by the information gathering station, as illustrated in FIG. 18.

In these examples, since the transmission device 1 forming the information gathering station knows the set wavelengths in all of the transmission devices in advance, it is able to change the wavelength selected by the operator via the OSC section to another wavelength as desired.

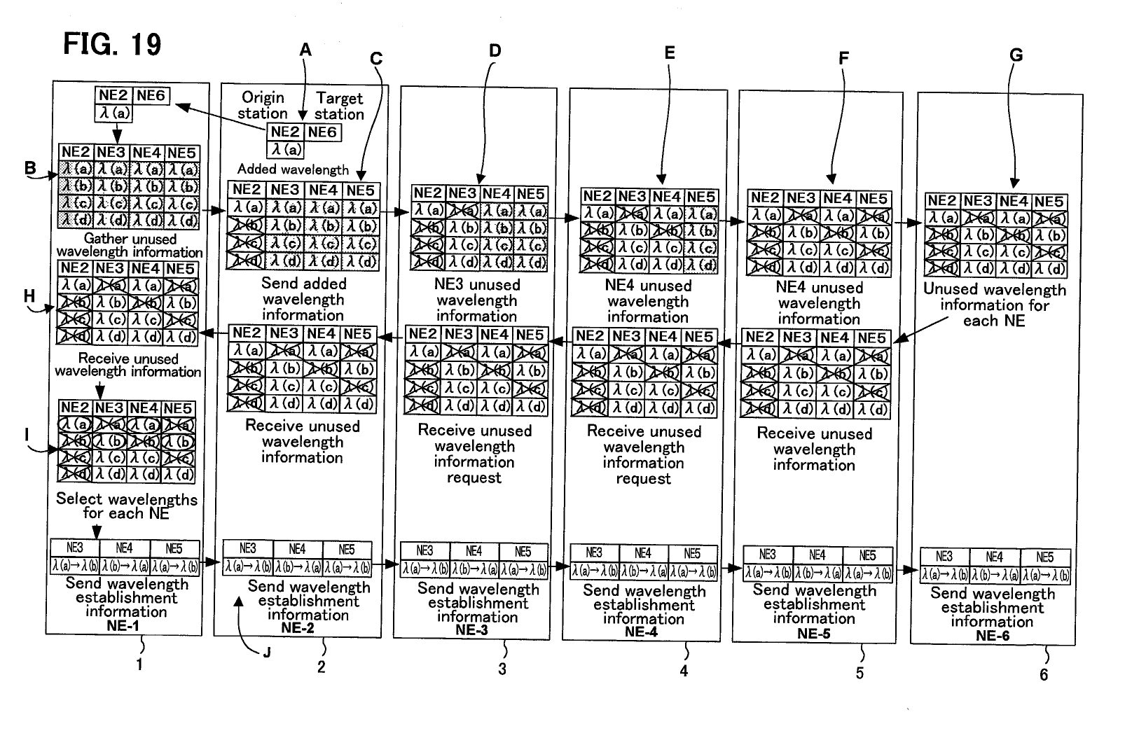

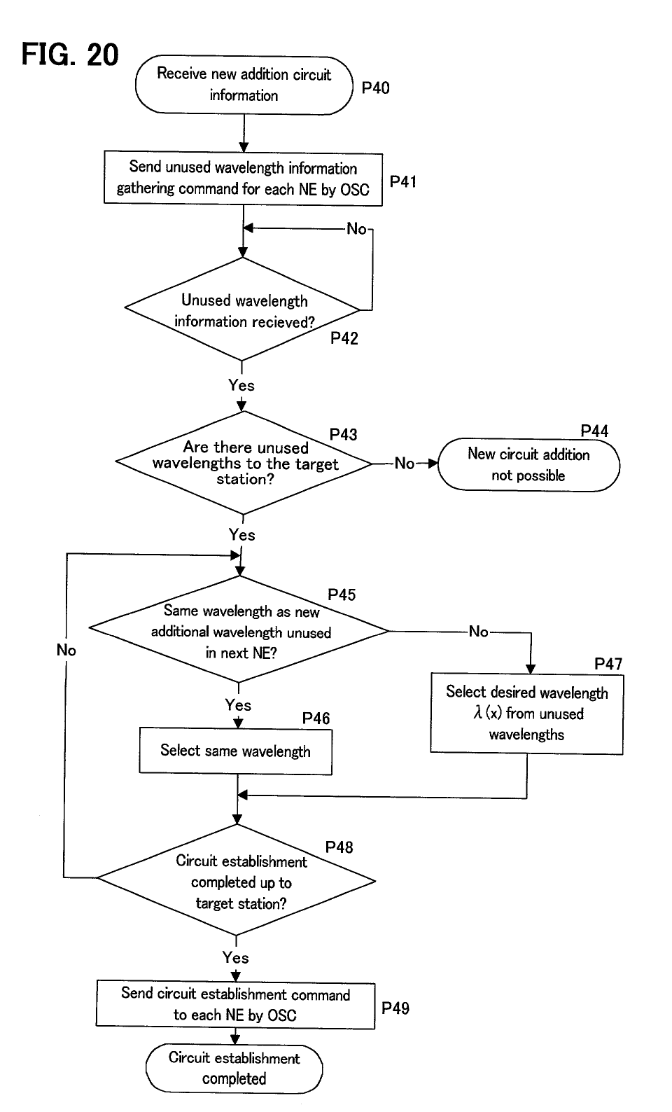

FIG. 19 is an example of a system composition for implementing a sixth embodiment of the present invention. It is supposed that transmission device 1 forms an information gathering station and that a new line is to be added between transmission device 2 and transmission device 6. FIG. 20 is a flowchart corresponding to FIG. 19, which shows the processing performed in the transmission device 1 forming the information gathering station, until establishment of the line. The operation of FIG. 19 is now described with reference to FIG. 20.

Firstly, the OSC section of transmission device 2 sends origin station information, target station information, and additional wavelength information to the transmission device 1 (FIG. 19, A). Upon receiving this new additional line information from transmission device 2 (processing step P40), the transmission device 1 sends out an unused wavelength information gathering command (FIG. 19, B) by means of the OSC optical signal, in order to gather unused wavelength information from transmission device 2 to transmission device 5 (processing step P41).

In other words, if λ(a) is the new addition wavelength in transmission device 2, as reported by transmission device 2, then it sends information for λ(a) (FIG. 19, C) via transmission device 2 to transmission device 3, using the OSC optical signal. At transmission device 3, the OSC section then sends information for the unused wavelengths λ(b), λ(c), λ(d), plus the information for the new additional wavelength λ(a) from transmission device 2 (FIG. 13, D), to transmission device 4, by means of the OSC optical signal.

At the transmission device 4, moreover, the OSC section then sends information for the unused wavelengths λ(a), λ(c), λ(d), plus the information for the unused wavelengths λ(b), λ(c), λ(d) from transmission device 3, plus the information for the new additional wavelength λ(a) from transmission device 2 (FIG. 13, E), to transmission device 5, by means of the OSC optical signal. Similarly, at transmission device 5, the OSC section then sends information for the unused wavelengths λ(b), λ(d), plus the information for the unused wavelengths λ(a), λ(c), λ(d) from transmission device 4, plus the information for the unused wavelengths λ(b), λ(c), λ(d) from transmission device 3, plus the information for the new additional wavelength λ(a) from transmission device 2 (FIG. 13, E), to transmission device 6, by means of the OSC optical signal.

The information gathered at transmission device 6 (FIG. 13, G) is then sent back in the reverse direction to transmission device 1, by means of the OSC optical signal.

The OSC section of transmission device 1 verifies that unused wavelength information has been received from each of the transmission devices (processing step P42), and it selects wavelengths on the basis of this information (FIG. 13, H) (processing step P43). If it is not possible to select unused wavelengths through to the target station, then it is considered that addition of the new line is not possible (processing step P44).

Wavelength selection for the respective transmission devices is performed as follows by the OSC section of the transmission device 1.

Namely, it judges whether to not the same wavelength as the new additional wavelength is unused in the next transmission device being subject to wavelength selection (processing step P45). If the same wavelength as the new additional wavelength is unused, then the same wavelength is selected (processing step P46), whereas if it is not unused, then another desired wavelength λ(x) is selected (processing step P47).

In the embodiment in FIG. 19, λ(a) is in use in transmission device 3, so a desired wavelength λ(b) is selected from the unused wavelengths thereof. In transmission device 4, λ(a) is unused, so λ(a) is selected. In transmission device 5, λ(a) is in use, so a desired wavelength λ(b) is selected from the unused wavelengths thereof (FIG. 13, I).

In this way, when line setting has been completed for each of the transmission devices (Yes at processing step P48), the transmission device 1 sends this wavelength information to the OSC sections of the respective transmission devices, by means of the OSC optical signal (processing step P49), and the wavelengths are set (FIG. 13, J).

Line settings can be made with respect to information in the reverse direction, from transmission device 6 to transmission device 2, by means of similar processing to the foregoing.

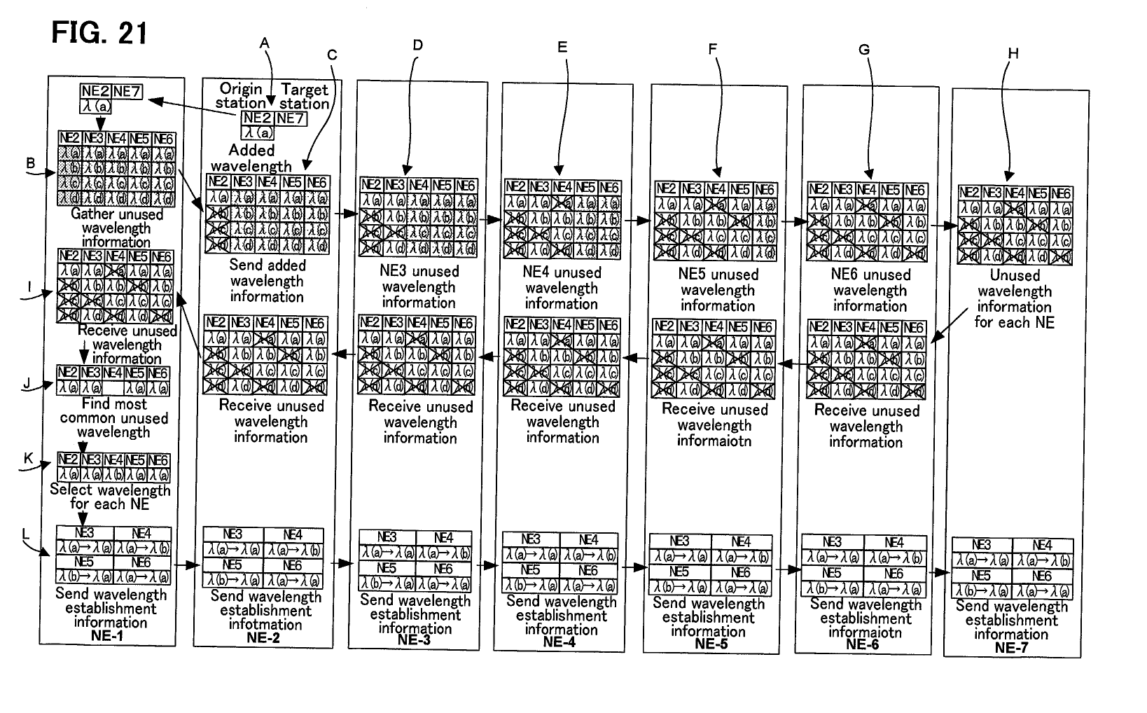

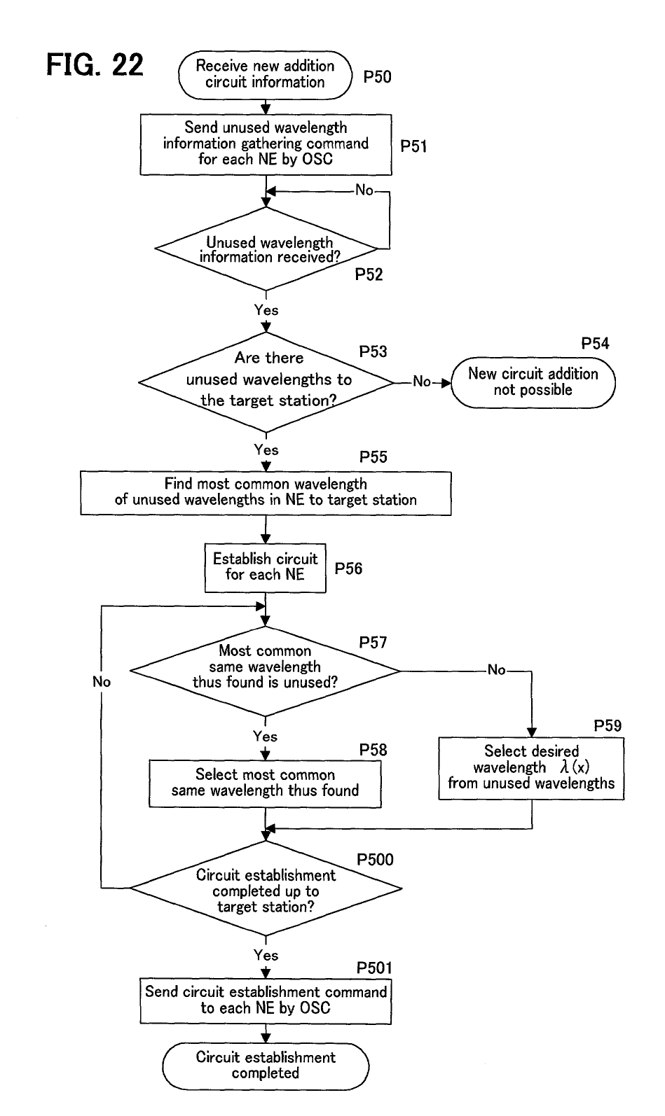

FIG. 21 shows a seventh embodiment of the present invention, wherein a new line is added between transmission device 2 and transmission device 7. FIG. 22 is a flowchart of processing in transmission device 1, which forms an information gathering station corresponding to FIG. 21. The processing of FIG. 21 is described below with respect to FIG. 22.

It is supposed that the transmission device 1 forms an information gathering station, and that a new line is to be added from transmission device 2 to transmission device 7.

Firstly, the OSC section of transmission device 2 sends origin station information, target station information, and additional wavelength information to the transmission device 1 (FIG. 21, A).

Upon receiving this new additional line information from transmission device 2 (processing step P50), the transmission device 1 the transmission device 1 sends out an unused wavelength information gathering command (FIG. 21, B) by means of the OSC optical signal, in order to gather unused wavelength information from transmission device 2 to transmission device 7 (processing step P51).

In other words, if λ(a) is the new addition wavelength in transmission device 2, as reported by transmission device 2 (FIG. 21, B), then it sends information for λ(a) (FIG. 19, C) to transmission device 3, using the OSC optical signal. At transmission device 3, the OSC section then sends information for the unused wavelengths λ(a), λ(b), λ(d), plus the information for the new additional wavelength λ(a) from transmission device 2 (FIG. 21, D), to transmission device 4, by means of the OSC optical signal.

At the transmission device 4, moreover, the OSC section then sends information for the unused wavelengths λ(b), λ(c), plus the information for the unused wavelengths λ(a), λ(b), λ(d) from transmission device 3, plus the information for the new additional wavelength λ(a) from transmission device 2 (FIG. 21, E), to transmission device 5, by means of the OSC optical signal.

Similarly, at transmission device 5, the OSC section then sends information for the unused wavelengths λ(a), λ(b), λ(c), plus the information for the unused wavelengths λ(b), λ(c) from transmission device 4, plus the information for the unused wavelengths λ(a), λ(b), λ(d) from transmission device 3, plus the information for the new additional wavelength λ(a) from transmission device 2 (FIG. 21, F), to transmission device 6, by means of the OSC optical signal.

At transmission device 6, the OSC section then sends information for the unused wavelengths λ(a), λ(b), λ(c), plus the information for the unused wavelengths λ(a), λ(c), λ(d) from transmission device 5, plus the information for the unused wavelengths λ(b), λ(c) from transmission device 4, plus the information for the unused wavelengths λ(a), λ(b), λ(d) from transmission device 3, plus the information for the new additional wavelength λ(a) from transmission device 2 (FIG. 21, G), to transmission device 7, by means of the OSC optical signal.

The information gathered at transmission device 7 (FIG. 21, H) is then sent to the transmission device 1 by means of the OSC optical signal.

The OSC section of transmission device 1 verifies the reception of the unused wavelength information (Yes at processing step P52), and selects wavelengths on the basis of this information (FIG. 21, I). It is judged whether or not wavelengths through to the target station can be selected (processing step P53), and if these wavelengths cannot be selected, then it is considered that additional of the new line is not possible (processing step P54).

The selection of these wavelengths is carried out as follows. Firstly, the most common wavelength of the unused wavelengths of the respective transmission devices is found (processing step P55), and a line is established in each of the transmission devices (processing step P56).

The line is established in the respective transmission devices in the following manner. In the example in FIG. 21, the most common unused wavelength is λ(a), and therefore λ(a) is selected preferentially (FIG. 21, J). Thereupon, it is judged whether or not this same most common wavelength thus found is unused in the respective transmission devices (processing step P57), and if wavelength λ(a) is not in use, then this wavelength is selected (processing step P58), whereas if it is in use, then an unused wavelength is selected as desired (processing step P59).

In the example of FIG. 21, λ(a) is being used in transmission device 4, so a desired wavelength of the unused wavelengths, λ(b), is selected (FIG. 21, K). In this way, a line is established is each of the transmission devices (processing step P500).

This information is sent to the OSC sections of the respective transmission devices, by means of the OSC optical signal (processing step P501), and the wavelengths are set accordingly (FIG. 21, I).

The transmission of information for establishing a line from transmission device 7 to transmission device 2 is similar to the foregoing description.

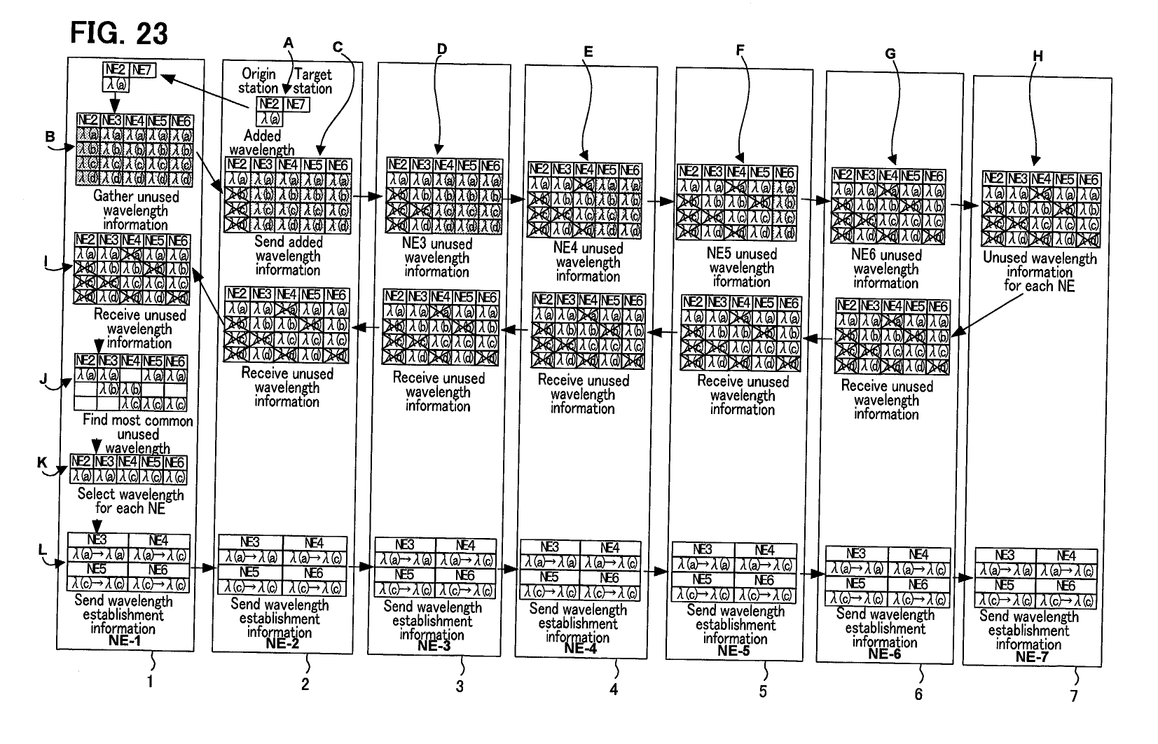

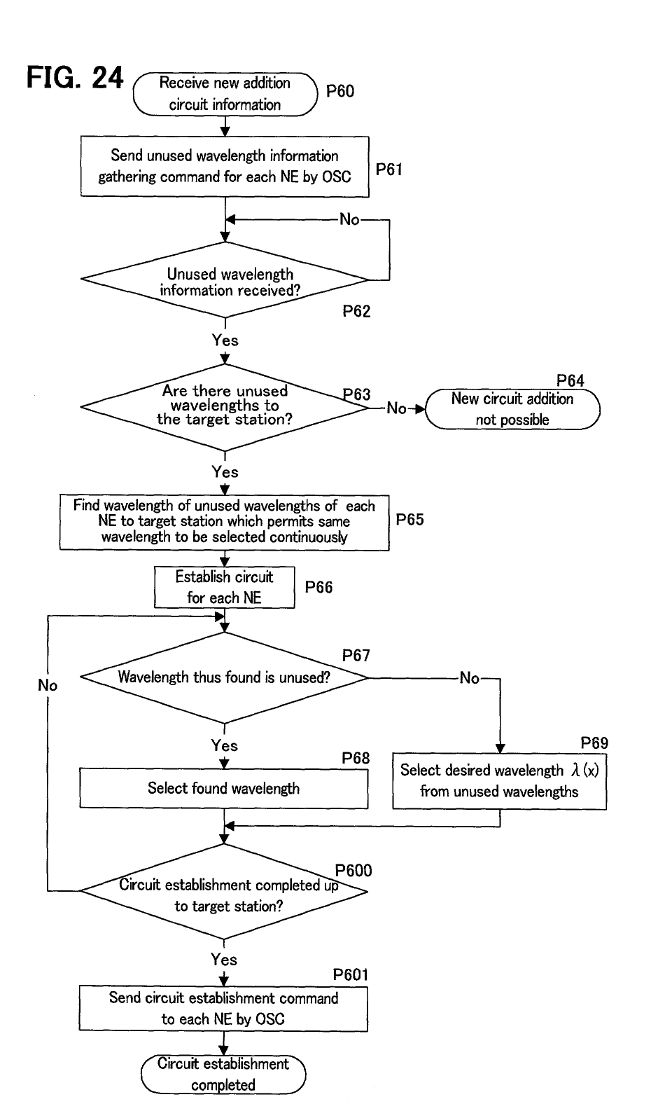

FIG. 23 is an example of a system composition for implementing an eighth embodiment of the present invention. FIG. 24 is a flowchart of the processing in transmission device 1, which forms an information gathering station corresponding to FIG. 23. The operation of FIG. 23 is now described with reference to FIG. 24.

It is supposed that transmission device 1 is taken as an information gathering station and a new line is to be added from transmission device 2 to transmission device 7. Firstly, the OSC section of transmission device 2 sends origin station information, target station information and additional wavelength information to transmission device 1, by means of the OSC optical signal, (FIG. 23, A).

Upon receiving this new additional line information from transmission device 2 (processing step P60), transmission device 1 sends out an unused wavelength information gathering request (FIG. 23, B) in order to gather unused wavelength information to transmission device 7 using the OSC optical signal (processing step P61).

The transmission device 1 then determines whether or not unused wavelength information has been received (processing step P62).

From the received unused wavelength information, transmission device 1 judges whether or not there are unused wavelengths through to the target station (processing step P63), and if there are no unused wavelengths, then it is considered that addition of the new line is not possible (processing step P64).

If there are unused wavelengths through to the target station, then transmission device 1 searches the unused wavelengths of the respective transmission devices to the target station for the wavelength which permits the same wavelength to be selected continuously (processing step P65), and a line is set up for each of the transmission devices (processing step P66).

Moreover, the setting of lines for the respective transmission devices is performed as follows.

In the example in FIG. 23, the unused wavelength of the respective transmission devices to the target station which permits the same wavelength to be used continuously is as shown in FIG. 21, J. Thereupon, it is determined whether or not the wavelength thus found is unused in the respective transmission devices (processing step P67), and if the found wavelength is not in used, then that wavelength is selected (processing step P68), whereas if it is in use, any other unused wavelength is selected (processing step P69).

In the example in FIG. 23, if λ(a) is the unused wavelength in transmission device 2, then information for λ(a) (FIG. 23, C) is sent to the transmission device 3 via the OSC optical signal. At transmission device 3, the OSC section then sends information for the unused wavelengths λ(a), λ(b), λ(d), plus the information for the new additional wavelength λ(a) from transmission device 2 (FIG. 23, D), to transmission device 4, by means of the OSC optical signal.

At the transmission device 4, moreover, the OSC section then sends information for the unused wavelengths λ(b), λ(c), plus the information for the unused wavelengths λ(a), λ(b), λ(d) from transmission device 3, plus the information for the new additional wavelength λ(a) from transmission device 2 (FIG. 23, E), to transmission device 5, by means of the OSC optical signal.

At transmission device 5, the OSC section then sends information for the unused wavelengths λ(a), λ(c), λ(d), plus the information for the unused wavelengths λ(b), λ(c) from transmission device 4, plus the information for the unused wavelengths λ(a), λ(b), λ(d) from transmission device 3, plus the information for the new additional wavelength λ(a) from transmission device 2 (FIG. 23, F), to transmission device 6, by means of the OSC optical signal.

At transmission device 6, the OSC section then sends information for unused wavelengths λ(a), λ(b), λ(c), plus the unused wavelengths λ(a), λ(c), λ(d) from transmission device 5, plus the information for the unused wavelengths λ(b), ζ(c) from transmission device 4, plus the information for the unused wavelengths λ(a), λ(b), λ(d) from transmission device 3, plus the information for the new additional wavelength λ(a) from transmission device 2 (FIG. 23, G), to transmission device 7, by means of the OSC optical signal.

The information gathered at transmission device 7 (FIG. 23, H) is then sent back to transmission device 1, by means of the OSC optical signal. The OSC section of transmission device 1 then selects wavelengths on the basis of this information (FIG. 23, I).

Firstly, it searches for a continuous wavelength amongst the unused wavelengths of the respective transmission devices (processing step P65).

Wavelength λ(a) is continuous between transmission device 2 and transmission device 3, and between transmission device 5 and transmission device 6, whereas wavelength λ(b) is continuous between transmission device 4 and transmission device 5. Wavelength λ(c) is continuous between transmission device 3 and transmission device 5, and wavelength λ(d) is not continuous anywhere (FIG. 23, J).

Therefore, λ(a) is selected preferentially between transmission device 2 and transmission device 3, λ(c) is selected preferentially between transmission device 4 and transmission device 6 (processing step P68: FIG. 23, K). This information is sent to the OSC sections of the respective transmission devices by means of the OSC optical signal, and the wavelengths are set accordingly (FIG. 23, L).

The information transmission and line establishment operations from the transmission device 7 to transmission device 2 are similar to the foregoing.

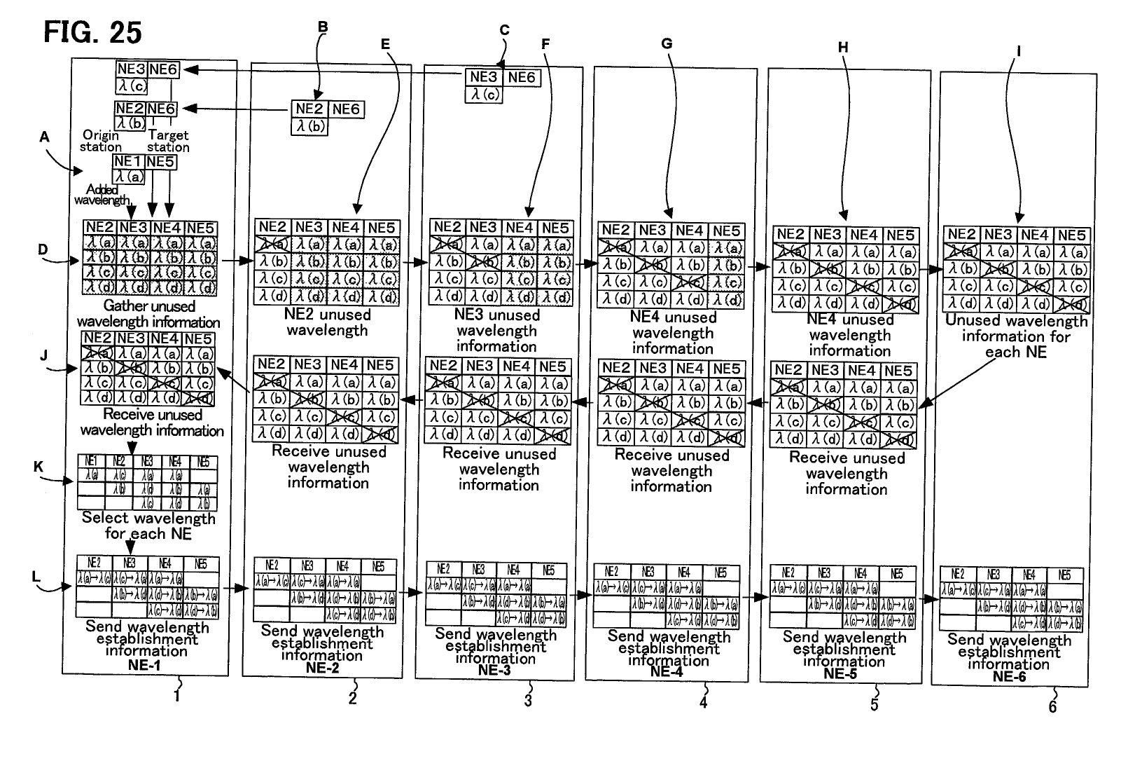

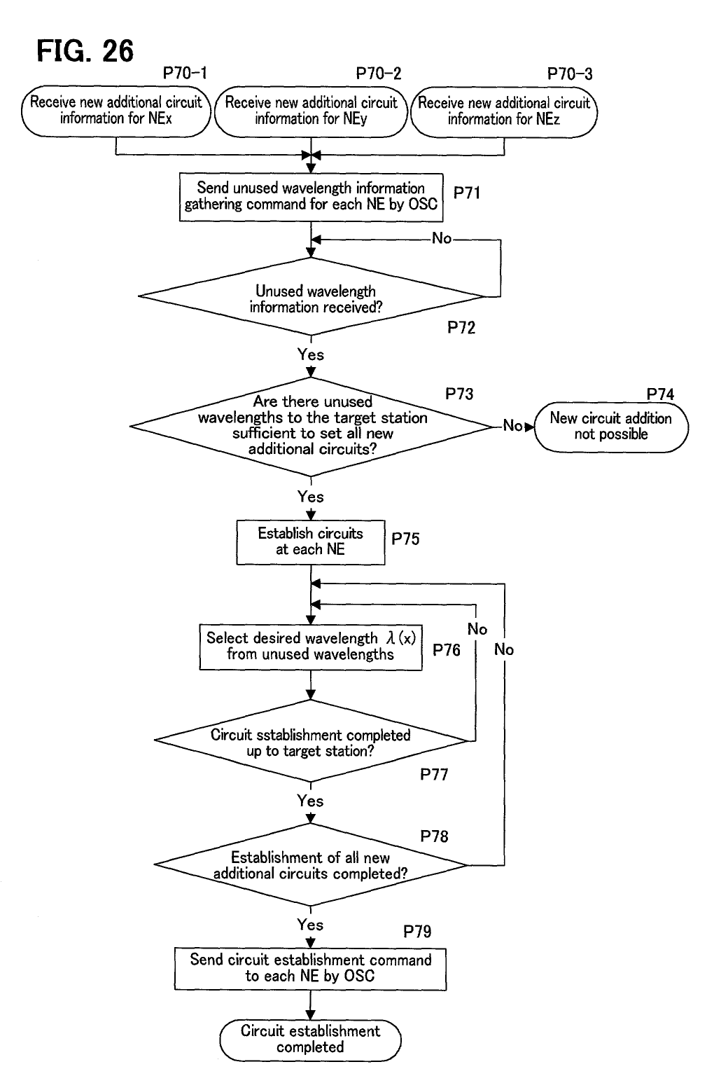

FIG. 25 is an example of a system composition for implementing a ninth embodiment of the present invention. FIG. 26 is a flowchart of processing in a transmission device 1 forming an information gathering station corresponding to FIG. 25. The operation of FIG. 25 is now described with reference to FIG. 26.

In the embodiment shown in FIG. 25, it is supposed that requests for different new additional lines are made at a plurality of transmission devices.

For example, if the transmission device forming the information gathering station receives additional line information from three transmission devices NEx, NEy and NEz (processing steps P70-1, P70-2, P70-3), then it sends out an unused wavelength information gathering request for the respective transmission devices, by means of the OSC optical signal (processing step P71).

In the example in FIG. 25, it is supposed that transmission device 1 is taken as the information gathering station, and that three lines are added simultaneously, one of λ(a) from transmission device 1 to transmission device 5, one of λ(b) from transmission device 2 to transmission device 6, and one of λ(c) from transmission device 3 to transmission device 6.

Firstly, an operator (not illustrated) sets origin station information, target station information and additional wavelength information at the OSC section of the transmission device 1 (FIG. 25, A).

An operator (not illustrated) also sets origin station information, target station information and additional wavelength information at the OSC section of the transmission device 2 (FIG. 25, B). Similarly, an operator (not illustrated) sets origin station information, target station information and additional wavelength information at the OSC section of the transmission device 3 (FIG. 25, C).

These three sets of new line addition information are gathered by transmission device 1 forming the information gathering station. On the basis of this information (FIG. 25, D), transmission device 1 sends out an unused wavelength information gathering request, by means of the OSC optical signal, in order to gather unused wavelength information from transmission device 1 to transmission device 6 (processing step P71).

At transmission device 2, the OSC section sends information relating to the unused wavelengths λ(b), λ(c), λ(d) (FIG. 25, E) to transmission device 3, by means of the OSC optical signal. The OSC section of transmission device 3 then sends information for the unused wavelengths λ(a), λ(c), λ(d), plus the information for unused wavelengths λ(b), λ(c), λ(d) from transmission device 2 (FIG. 25, F), to transmission device 4, by means of the OSC optical signal.

Similarly, the OSC section of transmission device 4 sends information for unused wavelengths λ(a), λ(b), λ(d), plus the information for the unused wavelengths λ(a), λ(c), λ(d) from transmission device 3, plus the information for unused wavelengths λ(b), λ(c), λ(d) from transmission device 2 (FIG. 25, G), to transmission device 5, by means of the OSC optical signal.

Moreover, the OSC section of transmission device 5 sends information for unused wavelengths λ(a), λ(b), λ(c), plus the information for unused wavelengths λ(a), λ(b), λ(d) from transmission device 4, plus the information for the unused wavelengths λ(a), λ(c), λ(d) from transmission device 3, plus the information for unused wavelengths λ(b), λ(c), λ(d) from transmission device 2 (FIG. 25, H), to transmission device 6, by means of the OSC optical signal.

Transmission device 6 then sends the gathered information (FIG. 25, I) to transmission device 1, via the OSC optical signal. The OSC section of transmission device 1 verifies reception of unused wavelength information in this information (FIG. 25, J) (processing step P72). Moreover, it determines whether or not there are unused wavelengths sufficient to establish all of the new additional lines (processing step P73). If there are not sufficient unused wavelengths to be able to establish all of the new additional lines, then it is considered that addition of the new lines is not possible (processing step P74).

If there are sufficient unused wavelengths to be able to establish all of the new additional lines, then the lines in the respective transmission devices are set up (processing step P75). The establishment of the line from transmission device 1 to transmission device 5 is carried out as follows.

Any desired unused wavelength λ(x) is selected (processing step P76), and a line is established to the target station (processing step P77). This is performed until establishment of all the new additional lines has been completed (processing step P78).

An example of line establishment in the embodiment shown in FIG. 25 is described below.

The line from transmission device 1 to transmission device 5 is established by selecting unused wavelengths, as desired, at transmission device 2, transmission device 3 and transmission device 4, respectively.

Transmission device 2 is already using λ(a), and a new wavelength λ(b) is to be added, so wavelength λ(c) is selected.

At transmission device 3, since λ(c) is newly added, a desired wavelength λ(a) is selected from the other unused wavelengths thereof. The transmission device 4 then selects a desired unused wavelength λ(a). The line from transmission device 2 to transmission device 6 is established by selecting desired unused wavelengths, respectively. At transmission device 3, since λ(a) was previously used as a wavelength selection for the line from transmission device 1 to transmission device 5, and λ(c) is to be newly added, a desired wavelength λ(d) from the remaining unused wavelengths thereof is selected.

At transmission device 4, since λ(a) was previously used for wavelength selection for the line from transmission device 1 to transmission device 5, a desired wavelength λ(b) is selected from the other unused wavelengths thereof. At transmission device 5, since λ(d) is in use, a desired wavelength λ(a) is selected from the other unused wavelengths thereof.

The line from transmission device 3 to transmission device 6 is established by selecting desired unused wavelengths, respectively. At transmission device 4, since both λ(a) and λ(b) were used in previous wavelength selections, a desired wavelength λ(d) is selected from the other unused wavelengths thereof. Moreover, at transmission device 5, since λ(a) was used in a previous wavelength selection, a desired wavelength λ(b) is selected from the other unused wavelengths thereof (FIG. 25, K).

When wavelength selection has been completed for all lines, the line establishment information is sent to the OSC sections of the respective transmission devices, by means of the OSC optical signal (processing step P79), and the wavelengths are established accordingly (FIG. 25, L).

The processing of the information transmission and line establishment from transmission device 6 to transmission device 1 is the same as that described above.

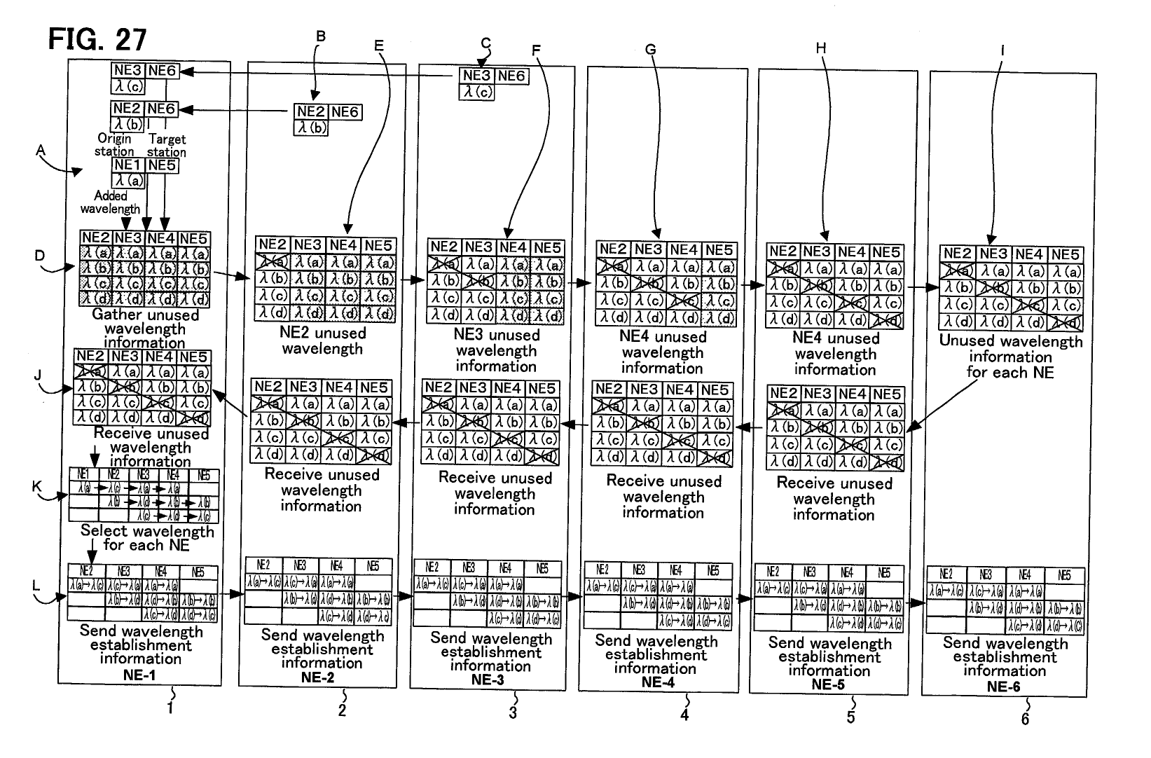

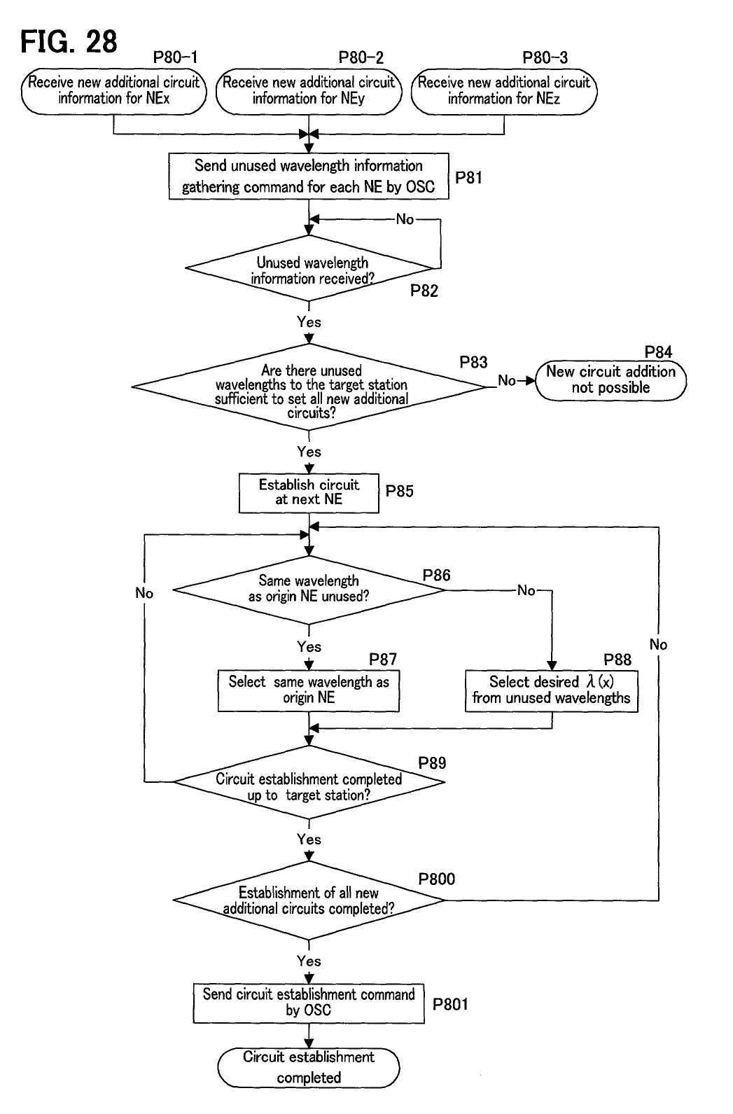

FIG. 27 is an example of a system composition for implementing a tenth embodiment of the present invention. FIG. 28 is a flowchart of the processing of an information gathering station corresponding to the embodiment in FIG. 27. The operation of FIG. 27 is now described with reference to FIG. 28.

In the embodiment in FIG. 27, requests for different new additional lines are made by a plurality of transmission devices, similarly to the embodiment shown in FIG. 25.

For example, if the transmission device forming the information gathering station receives additional line information from three transmission devices NEx, NEy and NEz (processing steps P80-1, P80-2, P80-3), then it sends out an unused wavelength information gathering request for the respective transmission devices, by means of the OSC optical signal (processing step P81).

In the example in FIG. 27, it is supposed that transmission device 1 is taken as the information gathering station, and that three lines are added simultaneously, one of λ(a) from transmission device 1 to transmission device 5, one of λ(b) from transmission device 2 to transmission device 6, and one of λ(c) from transmission device 3 to transmission device 6.

Firstly, an operator (not illustrated) sets origin station information, target station information and additional wavelength information at the OSC section of the transmission device 1 (FIG. 27, A).

An operator (not illustrated) also sets origin station information, target station information and additional wavelength information at the OSC section of the transmission device 2 (FIG. 27, B). Similarly, an operator (not illustrated) sets origin station information, target station information and additional wavelength information at the OSC section of the transmission device 3 (FIG. 27, C).

These three sets of new line addition information are gathered by transmission device 1 forming the information gathering station. On the basis of this information (FIG. 27, D), transmission device 1 sends out an unused wavelength information gathering request, by means of the OSC optical signal, in order to gather unused wavelength information from transmission device 2 to transmission device 5 (processing step P81).

At transmission device 2, the OSC section sends information relating to the unused wavelengths λ(b), λ(c), λ(d) (FIG. 27, E) to transmission device 3, by means of the OSC optical signal. The OSC section of transmission device 3 then sends information for the unused wavelengths λ(a), λ(c), λ(d), plus the information for unused wavelengths λ(b), λ(c), λ(d) from transmission device 2 (FIG. 27, F), to transmission device 4, by means of the OSC optical signal.

Similarly, the OSC section of transmission device 4 sends information for unused wavelengths λ(a), λ(b), λ(d), plus the information for the unused wavelengths λ(a), λ(c), λ(d) from transmission device 3, plus the information for unused wavelengths λ(b), λ(c), λ(d) from transmission device 2 (FIG. 27, G), to transmission device 5, by means of the OSC optical signal.

Moreover, the OSC section of transmission device 5 sends information for unused wavelengths λ(a), λ(b), λ(c), plus the information for unused wavelengths λ(a), λ(b), λ(d) from transmission device 4, plus the information for the unused wavelengths λ(a), λ(c), λ(d) from transmission device 3, plus the information for unused wavelengths λ(b), λ(c), λ(d) from transmission device 2 (FIG. 27, H), to transmission device 6, by means of the OSC optical signal.

Transmission device 6 then sends the gathered information (FIG. 27, I) to transmission device 1, via the OSC optical signal. The OSC section of transmission device 1 verifies reception of unused wavelength information in this information (FIG. 27, J) (processing step P82). Moreover, it determines whether or not there are unused wavelengths sufficient to establish all of the new additional lines (processing step P83). If there are not sufficient unused wavelengths to be able to establish all of the new additional lines, then it is considered that addition of the new lines is not possible (processing step P84).

If there are sufficient unused wavelengths to be able to establish all of the new additional lines, then the lines in the respective transmission devices are set up (processing step P85). The establishment of the line from transmission device 1 to transmission device 5 is carried out as follows.

It is determined whether or not the same wavelength as the origin transmission device is one of the unused wavelengths (processing step P86), and if this same wavelength is unused, then that wavelength is selected (processing step P87). If the same wavelength is not unused, then any desired wavelength λ(x) of the unused wavelengths is selected (processing step P88). Thereby, a line is established to the target station (processing step P89).

This is performed until establishment of all the new additional lines has been completed (processing step P800). When establishment of all of the new additional lines has been completed, a line setting command is sent to the respective transmission devices, by means of the OSC optical signal (processing step P801), whereupon line establishment is completed.

An example of line establishment in the embodiment shown in FIG. 27 is described below.

To establish the line from transmission device 1 to transmission device 5, at transmission device 2, since the wavelength λ(a) added at the origin transmission device 1 is in use, a desired wavelength λ(c) is selected from the unused wavelengths other than the newly added wavelength λ(b). At transmission device 3, the wavelength λ(a) added at the origin transmission device 1 is unused, and therefore this wavelength λ(a) is selected.

At transmission device 4, since the wavelength λ(a) added at the origin transmission device 1 is unused, this wavelength λ(a) is selected. In establishing the line from transmission device 2 to transmission device 6, at transmission device 3, since λ(a) was used in wavelength selection for the line from transmission device 1 to transmission device 4, and λ(c) is newly added, a desired wavelength λ(d) is selected from the other unused wavelengths thereof.

At transmission device 4, the wavelength λ(b) added by the origin transmission device 2 is unused, so this wavelength λ(b) is selected. At transmission device 5, the wavelength λ(b) added by the origin transmission device 2 is unused, so wavelength λ(b) is selected.

In establishing the line from transmission device 3 to transmission device 6, at transmission device 4, λ(c) is in use and λ(a) and λ(b) have already been used for previous wavelength selections, so a desired wavelength λ(d) is selected from the other unused wavelengths thereof.

At transmission device 5, since the wavelength λ(c) added by the origin transmission device 3 is unused, this wavelength λ(c) is selected (FIG. 27, K). When wavelength selection has been completed for all lines, the line establishment information is sent to the OSC sections of the respective transmission devices, and the wavelengths are established accordingly (FIG. 27, L).

The processing of the information transmission and line establishment from transmission device 6 to transmission device 1 is the same as that described above.

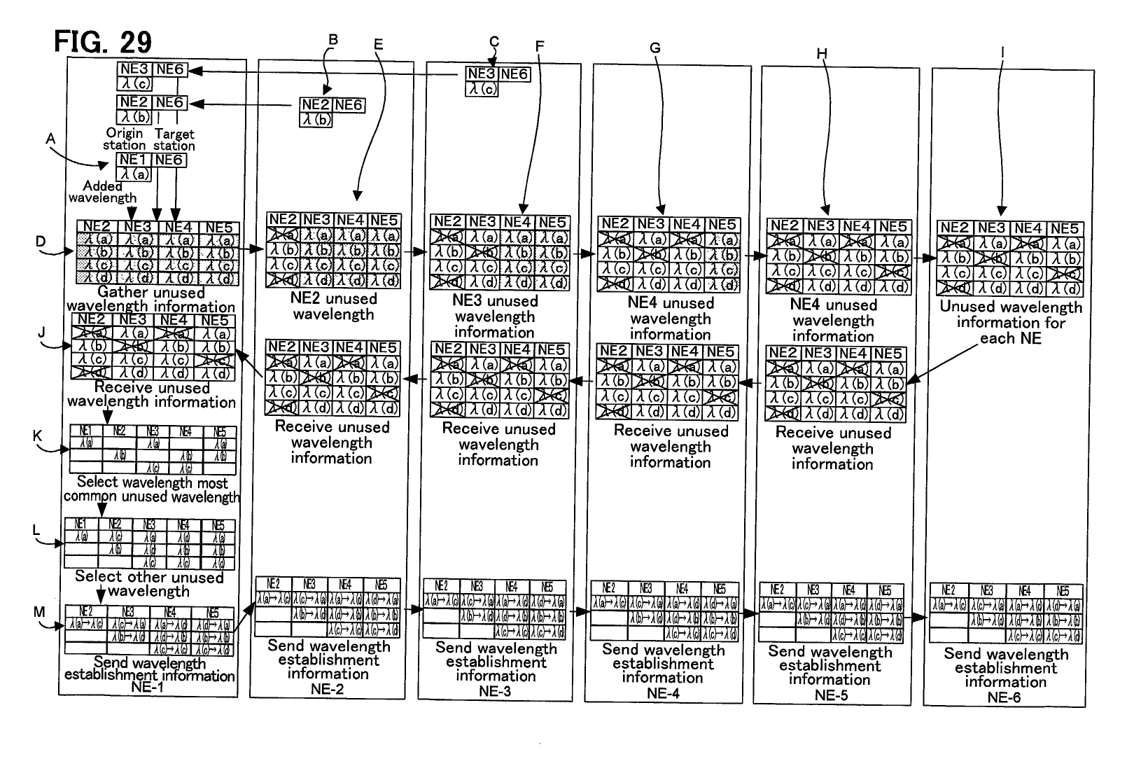

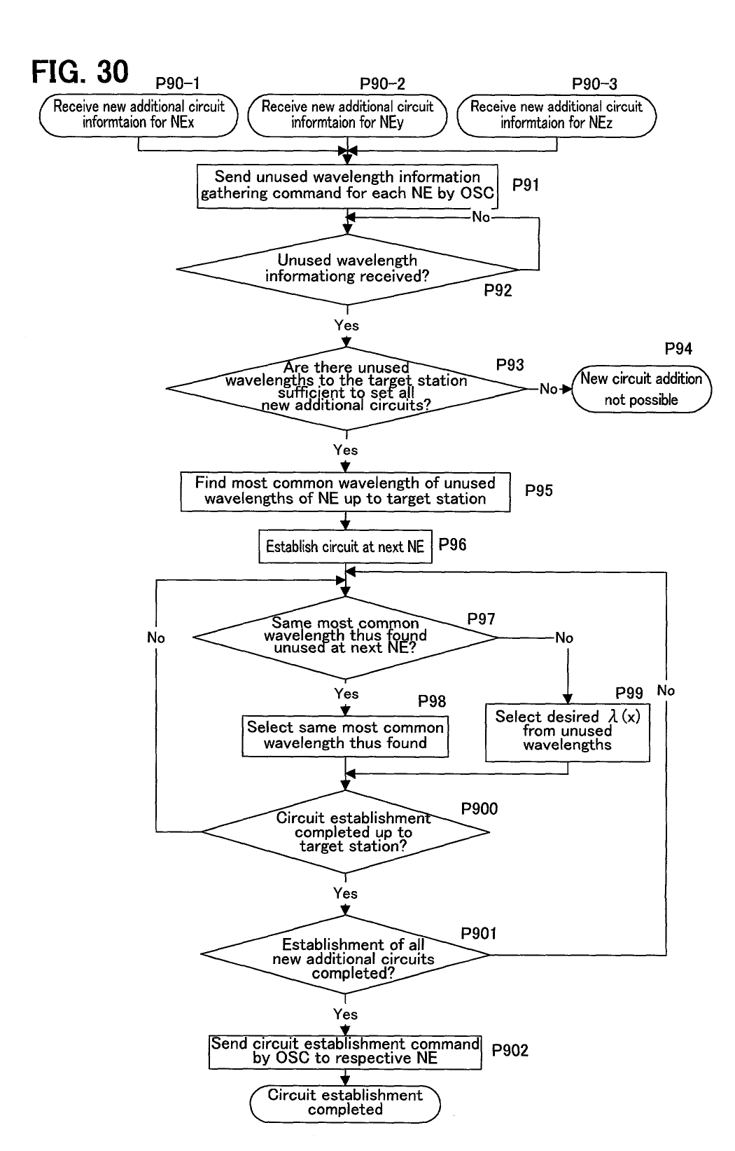

FIG. 29 is an example of a system composition for implementing an eleventh embodiment of the present invention. FIG. 30 is a flowchart of the processing of an information gathering station corresponding to the embodiment in FIG. 29. The operation of FIG. 29 is now described with reference to FIG. 30.

For example, if the transmission device forming the information gathering station receives additional line information from three transmission devices NEx, NEy and NEz (processing steps P90-1, P90-2, P90-3), then it sends out an unused wavelength information gathering request for the respective transmission devices, by means of the OSC optical signal (processing step P91).

In the example in FIG. 29, it is supposed that transmission device 1 is taken as the information gathering station, and that three lines are added simultaneously, one of λ(a) from transmission device 1 to transmission device 6, one of λ(b) from transmission device 2 to transmission device 6, and one of λ(c) from transmission device 3 to transmission device 6.

Firstly, origin station information, target station information and additional wavelength information for transmission device 1 is set via the OSC section of transmission device 1 (FIG. 29, A). Origin station information, target station information and additional wavelength information for transmission device 2 is set via the OSC section of transmission device 2 (FIG. 29, B). Origin station information, target station information and additional wavelength information for transmission device 3 is set via the OSC section of transmission device 3 (FIG. 29, C).

These three sets of new line addition information are gathered by transmission device 1 forming the information gathering station. Transmission device 1 sends out an unused wavelength information gathering request (FIG. 29, D), by means of the OSC optical signal, in order to gather unused wavelength information from transmission device 1 to transmission device 5 (processing step P92).

At transmission device 2, the OSC section sends information relating to the unused wavelengths λ(b), λ(c) (FIG. 29-E) to transmission device 3, by means of the OSC optical signal. The OSC section of transmission device 3 then sends information for the unused wavelengths λ(a), λ(c), λ(d), plus the information for unused wavelengths λ(b), λ(c) from transmission device 2 (FIG. 29-F), to transmission device 4, by means of the OSC optical signal.

The OSC section of transmission device 4 sends information for unused wavelengths λ(b), λ(c), λ(d), plus the information for the unused wavelengths λ(a), λ(c), λ(d) from transmission device 3, plus the information for unused wavelengths λ(b), λ(c) from transmission device 2 (FIG. 29-G), to transmission device 5, by means of the OSC optical signal.

The OSC section of transmission device 5 sends information for unused wavelengths λ(a), λ(b), λ(d), plus the information for unused wavelengths λ(b), λ(c), λ(d) from transmission device 4, plus the information for the unused wavelengths λ(a), λ(c), λ(d) from transmission device 3, plus the information for unused wavelengths λ(b), λ(c) from transmission device 2 (FIG. 29-H), to transmission device 6, by means of the OSC optical signal.

The information gathered in transmission device 6 (FIG. 29-I) is then sent to transmission device 1, via the OSC optical signal. The OSC section of transmission device 1 verifies reception of unused wavelength information (processing step P92), and determines whether or not there are unused wavelengths sufficient to establish all of the new additional lines (processing step P93). If there are not sufficient unused wavelengths, then it is considered that addition of the new lines is not possible (processing step P94).

If there are sufficient unused wavelengths, then transmission device 1 selects wavelengths on the basis of the unused wavelength information (FIG. 29, J) sent by transmission device 6. More specifically, it searches for the most common similar wavelength of the unused wavelengths of the transmission devices to the target station (processing step P95). It then establishes the next line in a similar manner (processing step P96).

This line establishment is carried out by the following method. It is determined whether or not the same most common wavelength thus found is unused in the next transmission device (processing step P97), and if that same wavelength is unused, then the wavelength is selected (processing step P98). If, on the other hand, the most common wavelength thus found is not unused, then a desired wavelength of the unused wavelengths is selected (processing step P99).

In this way, a line is established until the target station (processing step P900).

In the embodiment in FIG. 29, firstly, the most common unused wavelength between transmission device 1 and transmission device 5 is found (processing step P98).

Next, in order to establish a line from transmission device 1 to transmission device 6, since λ(a), λ(c) and λ(d) are most common similar wavelengths of the unused wavelengths in transmission device 2, transmission device 3, transmission device 4 and transmission device 5, and in the newly added line in transmission device 1, one of these wavelengths, namely, λ(a), is used preferentially.

In establishing a line from transmission device 2 to transmission device 6, the most common similar wavelength of the unused lines in transmission device 3, transmission device 4 and transmission device 5, and the newly added line in transmission device 2, is wavelength λ(b), so λ(b) is used preferentially.

In establishing a line from transmission device 3 to transmission device 6, the most common similar wavelengths of the unused lines in transmission device 4 and transmission device 5, and the newly added line in transmission device 3, are wavelengths λ(c) and λ(d), so one of these, namely, λ(c), is used preferentially. (FIG. 29, K)

Next, desired unused wavelengths are set in transmission devices in which the wavelength preferred for use is already being used (processing step P99).

In establishing the line from transmission device 1 to transmission device 6, since λ(a) is in use in transmission device 2 and transmission device 3, desired unused wavelengths of λ(c) and λ(d) are selected in transmission device 2 and transmission device 4, respectively.

In establishing the line from transmission device 2 to transmission device 6, since λ(b) is in use in transmission device 3, a desired unused wavelength λ(d) is selected. In establishing the line from transmission device 3 to transmission device 6, since λ(c) is in use in transmission device 5, a desired unused wavelength λ(d) is selected (FIG. 29, L).

When wavelength selection has been completed for all the line (processing step P901), the line establishment information is sent to the OSC sections of the respective transmission devices (processing step P902), and the wavelengths are set accordingly (FIG. 29, M).

The information sent from transmission device 6 to transmission device 1 is the same as that described above.

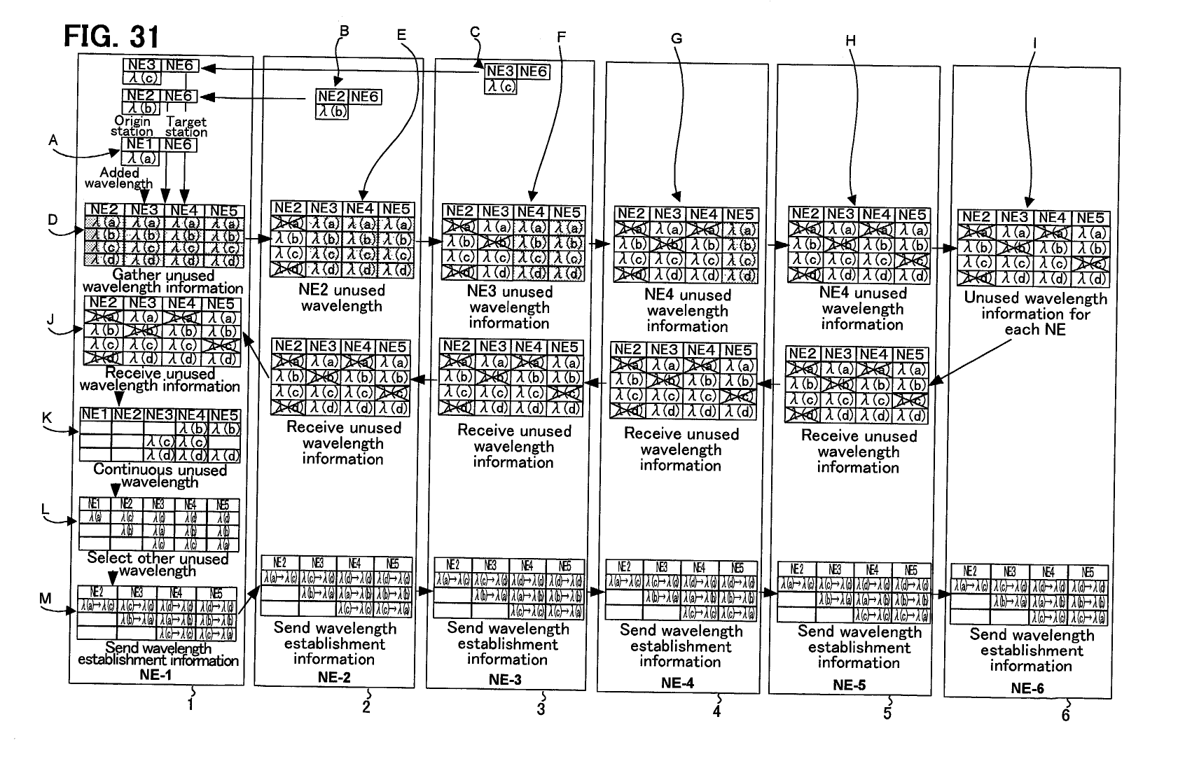

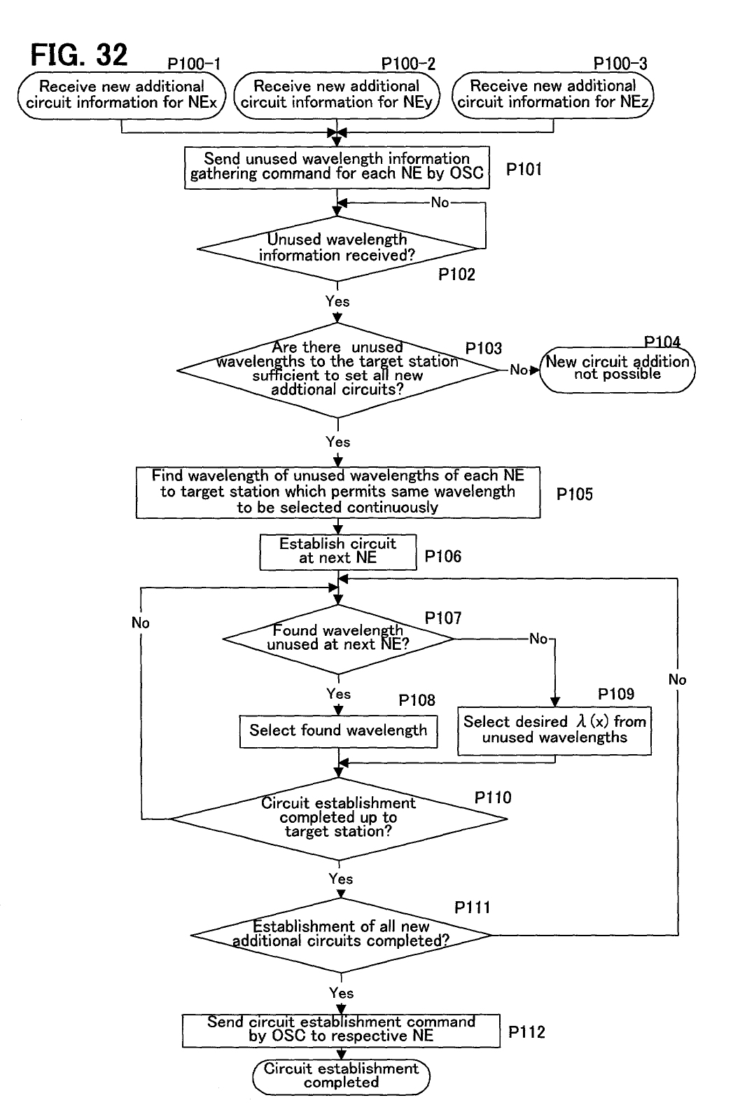

FIG. 31 is an example of a system composition for implementing an eleventh embodiment of the present invention. FIG. 32 is a flowchart of the processing of an information gathering station corresponding to the embodiment in FIG. 31.

In FIG. 31, it is supposed that transmission device 1 is taken as the information gathering station, and that three lines are added simultaneously, one of λ(a) from transmission device 1 to transmission device 6, one of λ(b) from transmission device 2 to transmission device 6, and one of λ(c) from transmission device 3 to transmission device 6.

For example, if the transmission device forming the information gathering station receives additional line information from three transmission devices, transmission device NEx, transmission device NEy and transmission device NEz (processing steps P100-1, P100-2, P100-3), then it sends out an unused wavelength information gathering command for the respective transmission devices, by means of the OSC optical signal (processing step P101).

In the example in FIG. 31, it is supposed that transmission device 1 is taken as the information gathering station, and that three lines are added simultaneously, one of λ(a) from transmission device 1 to transmission device 6, one of λ(b) from transmission device 2 to transmission device 6, and one of λ(c) from transmission device 3 to transmission device 6.

Firstly, origin station information, target station information and additional wavelength information for transmission device 1 is set by an operator via the OSC section of transmission device 1 (FIG. 31, A). Origin station information, target station information and additional wavelength information for transmission device 2 is set via the OSC section of transmission device 2 (FIG. 31, B).

Origin station information, target station information and additional wavelength information for transmission device 3 is set via the OSC section of transmission device 3 (FIG. 31, C). These three sets of new line addition information are gathered by transmission device 1 forming the information gathering station.

In other words, transmission device 1 sends out an unused wavelength information gathering command (FIG. 31, D), by means of the OSC optical signal, in order to gather unused wavelength information from transmission device 1 to transmission device 5 (processing step P101).

At transmission device 2, the OSC section sends information relating to the unused wavelengths λ(b), λ(c) (FIG. 31, E) to transmission device 3, by means of the OSC optical signal. The OSC section of transmission device 3 then sends information for the unused wavelengths λ(a), λ(c), λ(d), plus the information for unused wavelengths λ(b), λ(c) from transmission device 2 (FIG. 31, F), to transmission device 4, by means of the OSC optical signal.

The OSC section of transmission device 4 sends information for unused wavelengths λ(b), λ(c), λ(d), plus the information for the unused wavelengths λ(a), λ(c), λ(d) from transmission device 3, plus the information for unused wavelengths λ(b), λ(c) from transmission device 2 (FIG. 31, G), to transmission device 5, by means of the OSC optical signal.

The OSC section of transmission device 5 sends information for unused wavelengths λ(a), λ(b), λ(d), plus the information for unused wavelengths λ(b), λ(c), λ(d) from transmission device 4, plus the information for the unused wavelengths λ(a), λ(c), λ(d) from transmission device 3, plus the information for unused wavelengths λ(b), λ(c) from transmission device 2 (FIG. 31, H), to transmission device 6, by means of the OSC optical signal. The information gathered in transmission device 6 (FIG. 31, I) is then sent to transmission device 1, via the OSC optical signal.

The OSC section of transmission device 1 verifies reception of information from transmission device 6 (processing step P102), and determines whether or not there are unused wavelengths sufficient to establish all of the new additional lines (processing step P103).

If there are not sufficient unused wavelengths, then it is considered that addition of the new lines is not possible (processing step P104).

The transmission device 1 selects wavelengths on the basis of the unused wavelength information sent by transmission device 6 (FIG. 31, J). More specifically, it searches for the most common wavelength of the unused wavelengths of the transmission devices to the target station (processing step P105). It then establishes the next line in a similar manner (processing step P106).

This line establishment is carried out by the following method. It is determined whether or not the wavelength thus found is unused in the next transmission device (processing step P107), and if the wavelength is unused, then it is selected (processing step P108). If, on the other hand, the most common similar wavelength thus found is not unused, then a desired wavelength of the unused wavelengths is selected (processing step P109).

In this way, a line is established until the target station (processing step P110).

In the embodiment in FIG. 31, firstly, transmission device 1 searches for a wavelength amongst the unused wavelengths of the respective transmission devices which permits continuous connection using the same wavelength, from transmission device 1 to transmission device 5 (processing step P107).

In the embodiment in FIG. 31, the wavelength which permits continuous connection using the same wavelength from transmission device 1 to transmission device 6 is λ(b) between transmission device 4, transmission device 5 and transmission device 6, and λ(c) between transmission device 3, transmission device 4 and transmission device 5. Moreover, between transmission device 3, transmission device 4, transmission device 5 and transmission device 6, it is λ(d).

In this case, since the line added from transmission device 1 to transmission device 6 is the longest line, λ(d) is used preferentially. In establishing the additional line from transmission device 3 to transmission device 6, since wavelength λ(c) is newly added at transmission device 3, λ(c) is used preferentially. In establishing the additional line from transmission device 2 to transmission device 6, wavelength λ(b) is used preferentially (FIG. 31, K).

Next, desired unused wavelengths are set in transmission devices in which the wavelength preferred for use is already being used. In establishing the line from transmission device 1 to transmission device 6, since λ(d) is in use in transmission device 2, a desired unused wavelength λ(c) is selected.

In establishing the line from transmission device 2 to transmission device 6, since λ(b) is in use in transmission device 3, a desired unused wavelength λ(a) is selected. In establishing the line from transmission device 3 to transmission device 6, since λ(c) is in use in transmission device 5, a desired unused wavelength λ(a) is selected (FIG. 31, L).

When wavelength selection has been completed for all the line (YES at processing step P111), the line establishment information is sent to the OSC sections of the respective transmission devices (processing step P112), and the wavelengths are set accordingly (FIG. 31, M).

In the embodiment in FIG. 31 described above, the information sent from transmission device 6 to transmission device 1 is the same as that described above.

As described above in the embodiments with reference to the drawings, according to the present invention, it is possible to establish a new additional line readily, without affecting lines that are in use, in comparison to a conventional method.

What is claimed is:

1. An optical wavelength division multiplexing transmission system having a plurality of cascaded transmission devices respectively having optical wavelength division multiplexing functions;
wherein said plurality of transmission devices each comprise a management section for managing used and unused wavelengths; and
the respective transmission devices located in a section where a new additional line is to be established allocate an unused wavelength to said new additional line, on the basis of the unused wavelength information held by said management sections, thereby ensuring a route going to the target transmission device.

2. The optical wavelength division multiplexing transmission system according to claim 1, wherein, when allocating an unused wavelength to said new additional line, the respective transmission devices located in the section where said new additional line is to be established preferentially use the same wavelength as the wavelength of the new additional line received from the previous station.

3. The optical wavelength division multiplexing transmission system according to claim 2, wherein, when allocating an unused wavelength to said new additional line, the respective transmission devices located in the section where said new additional line is to be established preferentially use the same unused wavelength as the wavelength used for said new additional line by the transmission device where said new additional line is added.

4. The optical wavelength division multiplexing transmission system according to claim 1, wherein the unused wavelength or used wavelength information for all of the respective transmission devices located in the section where said new additional line is to be established is gathered collectively at the transmission device where the new additional line is to be added, and this transmission device where said new additional line is to be added allocates wavelengths, as desired, according to said collectively gathered unused wavelength information.

5. The optical wavelength division multiplexing transmission system according to claim 1, wherein the unused wavelength or used wavelength information for all of the respective transmission devices located in the section where said new additional line is to be established is gathered collectively at an end transmission device serving as an information gathering station, and said information gathering station optionally allocates wavelengths, according to said gathered unused wavelength information.

6. The optical wavelength division multiplexing transmission system according to claim 5, wherein, when allocating an unused wavelength to said new additional line, the respective transmission devices located in the section where said new additional line is to be established preferentially use the same unused wavelength as the wavelength used for said new additional line by the transmission device where said new additional line is added.

7. The optical wavelength division multiplexing transmission system according to claim 5, wherein, when allocating an unused wavelength to said new additional line, the respective transmission devices located in the section where said new additional line is to be established preferentially use the most common unused wavelength in the respective transmission devices.

8. The optical wavelength division multiplexing transmission system according to claim 5, wherein, when allocating an unused wavelength to said new additional line, the respective transmission devices located in the section where said new additional line is to be established preferentially use the most common continuous unused wavelengths.

9. The optical wavelength division multiplexing transmission system according to claim 1, wherein the unused wavelength or used wavelength information for all of the respective transmission devices located in a plurality of sections where respective additional lines are to be established is gathered collectively at an end transmission device serving as an information gathering station, and said information gathering station optionally allocates wavelengths according to said gathered unused wavelength information.

10. The optical wavelength division multiplexing transmission system according to claim 9, wherein, when allocating an unused wavelength to said new additional line, the respective transmission devices located in the sections where said new additional lines are to be established preferentially use the same unused wavelength as the wavelength used for said new additional line by the transmission device where said new additional line is added.

11. The optical wavelength division multiplexing transmission system according to claim 9, wherein, when allocating an unused wavelength to said new additional line, the respective transmission devices located in the sections where said new additional lines are to be established preferentially use the most common unused wavelength in the respective transmission devices.

12. The optical wavelength division multiplexing transmission system according to claim 9, wherein, when allocating an unused wavelength to said new additional line, the respective transmission devices located in the sections where said new additional lines are to be established preferentially use the most common continuous unused wavelengths.
